(19) United States
(12) Patent Application Publication
(10) Pub. No.: US 2016/0158603 A1
(43) Pub. Date: Jun. 9, 2016

(54) ASSEMBLY FOR APPLYING A FORCE

(71) Applicant: INTELLIGENT RESISTANCE LTD, Twickenham Middlesex (GB)

(72) Inventors: Alastair Darwood, Twickenham Middlesex (GB); Nicholas Rose, Twickenham Middlesex (GB)

(73) Assignee: Intelligent Resistance Ltd., Twickenham Middlesex (GB)

(21) Appl. No.: 14/906,986

(22) PCT Filed: Jul. 24, 2014
(86) PCT No.: PCT/GB2014/052269

§ 371 Date: Jan. 22, 2016

(30) Foreign Application Priority Data
Jul. 24, 2013 (GB) 1313214.7

(51) Int. Cl. A63B 24/00; G06F 19/00

(52) U.S. Cl. CPC A63B 24/0075; G06F 19/3481; A63B 24/0087; A63B 24/0062; A63B 2024/009; A63B 2220/51

(57) ABSTRACT

An assembly (10) for applying a force to a user includes a force application unit (14) and a force receiving element (12), wherein the force application unit (14) is operable to apply a force to the force receiving element (12). A method for operating the assembly (10) includes obtaining or selecting a scenario code which governs a virtual environment or objective for a user's operation of the assembly. The method also includes selecting one or more configurable algorithms from a library in dependence on the scenario code. The method also includes obtaining operation data in dependence on the scenario code, the operation data providing a measurement relating to a user's operation of the assembly (10). The method also includes configuring and compiling into a master algorithm the one or more configurable algorithms in dependence on the scenario code and the operation data.

The present invention relates to an assembly for applying a force to a user, to a force receiving element for such an assembly, to a system for controlling such an assembly, and to a method for operating or using such an assembly.

Musculoskeletal injury and disease forms a large percentage of health related issues in the world today. With a recent increase in the incidence of operations such as joint replacements and musculoligementous surgery, there is an ever-increasing need to take the art of musculoskeletal rehabilitation and diagnostics into the digital age.

Until now, rehabilitative and diagnostic aids have been left in the wake of innovative surgical and medical devices. These allow ever more complex procedures to be undertaken, enabling clinical professionals to probe the cutting edge of patient treatment. Despite this, the rehabilitative tools offered to patients today remain dated technologies, such as elastic bands or free weights.

Furthermore, the line between normal exercise and active rehabilitation is clouded. Resistive exercise in general is a field that has remained largely unchanged for the last century. Gym machinery is often expensive but restricted to performing a relatively limited exercise pattern.

Furthermore, recent developments in gaming have led to an increased desire for physical interaction with the game.

U.S. Pat. No. 4,544,154 discloses a passive programmable resistance device. The device uses a closed loop feedback for controlling resistance. However, it is still relatively restricted in the predetermined exercise patterns it is able to offer. Functionality must be independently pre-programmed in the form of fixed ‘stroke profiles’.

The present invention seeks to provide an improved assembly, force receiving element, system and method.

According to an aspect of the invention, there is provided a method of operating an assembly for applying a force to a user, wherein the assembly includes a force application unit and a force receiving element, wherein the force application unit is operable to apply a force to the force receiving element; the method including:
obtaining or selecting a scenario code, the scenario code governing a virtual environment or objective for a user's operation of the assembly;
selecting one or more configurable algorithms from a library in dependence on the scenario code, the library including a plurality of configurable algorithms, the one or more configurable algorithms being for influencing an interaction between the assembly and a user;
obtaining operation data in dependence on the scenario code, the operation data providing a measurement relating to a user's operation of the assembly;
configuring and compiling into a master algorithm the one or more configurable algorithms in dependence on the scenario code and the operation data.

In embodiments of the invention, a master algorithm can be calculated which provides a bespoke operation of the assembly by selecting, configuring and compiling individual algorithms from a library into a master algorithm.

The method is preferably operated on a processor. The assembly can be an exercise device.

The scenario code can be an overarching goal set for a user.

In addition to selecting one or more configurable algorithms from a library, the method may also include selecting one or more non-configurable algorithms from the library, and these may also be compiled into the master algorithm. Non-configurable algorithms may for example influence the configuration or operation of other algorithms.

The operation data can be obtained from one or more detectors or sensors in the assembly. Obtaining operation data can include operating the one or more detectors or sensors to detect or sense the operation data.

Obtaining or selecting a scenario code can be in respect to a user's input or action.

Configuring and compiling can be the same step. For example, the step of compiling can compile the algorithms so that some algorithms are dependent on other algorithms, which also serves to configure the algorithms. However, configuring and compiling can be separate steps where the algorithms are configured and then subsequently compiled into the master algorithm.

Configuring and compiling into the master algorithm the one or more configurable algorithms can include configuring each of the one or more configurable algorithms.

The method preferably includes operating the force application unit to apply a force to the force receiving element in accordance with the master algorithm. In other words, the master algorithm is executed and the force application unit is operated in accordance with the results. For example, the results may include a force to be applied to the force receiving element

Operating the force application unit to apply a force to the force receiving element in accordance with the master algorithm can include operating the force application unit to apply a force to the force receiving element in accordance with an output of the master algorithm, the output of the master algorithm being dependent on the operation data.

Configuring and compiling into a master algorithm the one or more configurable algorithms in dependence on the scenario code and the operation data can include assigning a priority to each of the one or more configurable algorithms within the master algorithm.

A measurement relating to a user's operation of the assembly can include a measurement of a position and/or movement of a user and/or relating to a force applied by a user. Position can include orientation. Movement can include velocity and/or acceleration.

The method can include selecting from the library, in dependence on the scenario code and/or the operation data, one or more calculation algorithms for performing calculations on the operation data, and compiling the one or more calculation algorithms into the master algorithm, wherein an output of the master algorithm is dependent on a calculation from the one or more calculation algorithms.

One or more configurable algorithms can be for influencing a force applied to the force receiving element.

The library can include a plurality of configuring algorithms for influencing the configuration of other algorithms, and the method can include selecting from the library, in dependence on the scenario code and/or the operation data, one or more configuring algorithms, and compiling the master algorithm whereby one or more of the one or more configurable algorithms is configured in dependence on the one or more configuring algorithms. This can include the one or more configuring algorithms configuring one or more of the configurable algorithms for compilation and/or compiling the one or more configuring algorithms themselves into the master algorithm to provide a configuration to one or more of the configurable algorithms.

Configuring algorithms can in some instances themselves be configurable.

The one or more configuring algorithms can be for performing a calculation on the operation data, and the method can include compiling the master algorithm whereby one or more of the one or more configurable algorithms is configured in dependence on the calculation. The one or more configurable algorithms can be configured in dependence upon a specific instance of the calculation, and/or can be configured to be dependent upon future instances of the calculation.

The method can include compiling the master algorithm whereby a second algorithm is configured in dependence on a first algorithm, the operation data and the scenario code.

The method can include selecting the one or more configurable algorithms from the library in dependence upon the scenario code and the operation data.

References to the operation data herein do not necessarily all refer to the same values of data; different steps of the method may utilise the same or different dimensions of the operation data or some of the same and/or some different dimensions, and/or sections of the operation data from different or partially different time periods.

The method can include reviewing the operation data for compliance with the scenario code and if the operation data is outside a predetermined tolerance:
changing which algorithms are included in the one or more configurable algorithms in dependence on the scenario code and the operation data; and
compiling into the master algorithm the one or more configurable algorithms in dependence on the scenario code and the operation data.

If the operation data is outside a predetermined tolerance, the method can also include:
changing which non-configurable algorithms are to be included in the master algorithm in dependence on the scenario code and the operation data; and
compiling into the master algorithm the selected non-configurable algorithms in dependence on the scenario code and the operation data.

Compiling into the master algorithm the one or more configurable algorithms in dependence on the scenario code and the operation data can include configuring and compiling into the master algorithm the one or more configurable algorithms in dependence on the scenario code and the operation data.

Changing which algorithms are included in the one or more configurable algorithms can include selecting one or more additional configurable algorithms from the library and/or replacing one or more previously selected algorithms with a different configurable algorithm from the library.

The method can include:
reviewing the operation data for compliance with the scenario code; and, if the operation data is outside a predetermined tolerance:
reconfiguring and/or recompiling into the master algorithm the one or more configurable algorithms in dependence on the scenario code and the operation data.

Reconfiguring and/or recompiling into the master algorithm the one or more configurable algorithms in dependence on the scenario code and the operation data can include reassigning a priority to each of the one or more configurable algorithms within the master algorithm.

Preferably, the reviewing is performed repeatedly, preferably continuously.

Preferably, the reviewing is performed repeatedly during movement of the force receiving element.

In embodiments:
selecting one or more configurable algorithms from a library;
configuring and compiling into a master algorithm the one or more configurable algorithms;
changing which algorithms are included in the one or more configurable algorithms;
compiling into the master algorithm the one or more configurable algorithms; and/or
reconfiguring and/or recompiling into the master algorithm the one or more configurable algorithms;
is dependent on past operation data.

Obtaining or selecting scenario code can include selecting scenario code from a scenario code library in response to a user's input.

The operation data can include data indicating a position of a user and data indicating a position of the force receiving element.

The method can include determining a force through a predetermined body part of a user using a force measurement algorithm, the force measurement algorithm using the data indicating a position of a user and the data indicating a position of the force receiving element. The force measurement algorithm can be compiled into the master algorithm.

The method can include limiting a force through a predetermined body part of a user using the force measurement algorithm.

The operation data can include first, second and third classes of variables; wherein the first, second and third classes of variables relate, respectively to position, orientation, and kinematic variables, of at least one component of the assembly, or of the user.

According to an aspect of the invention, there is provided computer program code for performing a method as described herein when executed on a computing device.

According to an aspect of the invention, there is provided a system for operating an assembly for applying a force to a user, including:
a library including a plurality of configurable algorithms for influencing an interaction between an assembly and a user;
at least one input for receiving operation data providing a measurement of a user's operation of an assembly;
at least one output for controlling a force applied to a force receiving element of an assembly; and
a processor operable:
   to obtain or select scenario code, the scenario code governing a virtual environment or objective for a user's operation of an assembly,
   to select one or more configurable algorithms from the library in dependence on the scenario code,
   to obtain operation data in dependence on the scenario code from data received via the at least one input;
   to configure and compile into a master algorithm the one or more configurable algorithms in dependence on the scenario code and the operation data, and
   to provide an output via the at least one output to control an assembly in accordance with the master algorithm.

The master algorithm can be for providing an algorithm output dependent on the operation data, and the processor can be operable to provide an output via the at least one output in accordance with the algorithm output. This can be as a result of one or more of the selected configurable algorithms being for providing an output dependent on the operation data.

The processor can be operable to assign a priority to each of the one or more configurable algorithms within the master algorithm. It can also be operable to assign a priority to any non-configurable algorithms in the master algorithm.

The processor can be operable to obtain scenario code in response to a user's input or action.

The processor can be operable to select from the library, in dependence on the scenario code and/or the operation data, a calculation algorithm to perform a calculation on the operation data, wherein the processor is operable to compile the calculation algorithm into the master algorithm to provide an algorithm output dependent on the calculation, and wherein the processor is operable to provide an output via the at least one output in accordance with the algorithm output.

The library can include algorithms for influencing a force applied to a force receiving element of an assembly.

The library can include a plurality of non-configurable algorithms and the processor can be operable to select one or more non-configurable algorithms from the library in dependence on the scenario code and/or the operation data and to compile them into the master algorithm in dependence on the operation data.

The master algorithm can be for influencing a force applied to a force receiving element and the processor is operable to provide an output via the at least one output to control an assembly to apply a force to a force receiving element in dependence on the master algorithm.

The library can include a plurality of configuring algorithms for influencing the configuration of other algorithms, and the processor can be operable to select from the library, in dependence on the scenario code and/or the operation data, one or more configuring algorithms, and to compile the master algorithm whereby one or more of the one or more configurable algorithms is configured in dependence on the one or more configuring algorithms.

One or more of the configuring algorithms in the library can be for performing a calculation on the operation data and the processor can be operable to compile the master algorithm whereby one or more of the one or more configurable algorithms is configured in dependence on the calculation.

The processor can be operable to compile the master algorithm whereby a second algorithm is configured in dependence on a first algorithm, the operation data and the scenario code.

The processor can be operable to select the one or more configurable algorithms from the library in dependence upon the scenario code and the operation data.

The processor can be operable to review the operation data for compliance with the scenario code, and, if the operation data is outside a predetermined tolerance:
to change which algorithms are included in the one or more configurable algorithms in dependence on the scenario code and the operation data, and to compile into the master algorithm the one or more configurable algorithms in dependence on the scenario code and the operation data; and/or
to reconfigure and/or recompile into the master algorithm the one or more configurable algorithms in dependence on the scenario code and the operation data.

In embodiments, if the operation data is outside the predetermined tolerance, the processor is operable to change which algorithms are included in the one or more configurable algorithms in dependence on the scenario code and the operation data, and to configure and compile into the master algorithm the one or more configurable algorithms in dependence on the scenario code and the operation data.

The processor can be configured to review the operation data repeatedly or and/or continuously.

The processor can be configured to review the operation data repeatedly during movement of a force receiving element.

The system can included a memory for storing past operation data, wherein the processor is operable to:
select the one or more configurable algorithms from the library;
change which algorithms are included in the one or more configurable algorithms;
compile into the master algorithm the one or more configurable algorithms; and/or
reconfigure and/or recompile into the master algorithm the one or more configurable algorithms;
in dependence upon past operation data.

As operation data is obtained, the processor can be operable to store the operation data in the memory.

The system can include a scenario code library, wherein the processor is operable to obtain or select the scenario code from the scenario code library in response to a user's input or action.

The processor can be operable to determine a force through a predetermined body part of a user using a force measurement algorithm using data indicating a position of a user and data indicating a position of a force receiving element. The force measurement algorithm can be one of the configuring and/or configurable algorithms in the library.

The processor can be operable to limit a force through a predetermined body part of a user using the force measurement algorithm. The library can include an algorithm for limiting the force through a predetermined body part which can be the same as, or can be configured by, the force measurement algorithm.

According to an aspect of the invention, there is provided an assembly for applying a force to a user, including:
a system as described above;
a force receiving element; and
a force application unit for applying a force to the force receiving element in accordance with the at least one output of the system.

The assembly can include a sensor operable to sense data indicating a position of a user and data indicating a position of the force receiving element.

The assembly can include a sensor operable to determine a measurement of a position and/or movement of a user and/or relating to a force applied by a user and to provide the measurement to the at least one input.

The assembly can include a sensor operable to determine operation data including first, second and third classes of variables; wherein the first, second and third classes of variables relate, respectively to position, orientation, and kinematic variables, of at least one component of the assembly, or of a user and to provide the measurement to the at least one input.

The operation data referred to herein is generally obtained in dependence on the scenario code. However, in some embodiments operation data may be used which is not obtained in dependence upon the scenario code.

Embodiments of the present invention are able to vary the force applied to the force receiving element in a more complex way than by being determined solely by instantaneous values. In particular, the user's past behaviour can have an effect on the force that the assembly is applying to the force receiving element and in particular on the response of the assembly to future behaviour.

For example, as described below, some embodiments of the invention can simulate kicking a virtual football by applying a sudden impact force at a given extension of cable. However, if the past behaviour of the user means that the user is now not in the right place for kicking the virtual football, or has previously moved the virtual football, then this can affect whether the force application unit applies a sudden impact force to the user at that given extension of the cable.

Embodiments of the invention allow for continuous monitoring and continuous adaption of the inputs with respect to current user's performance and/or intervention criteria.

The operation data can be any data which the assembly is operable to detect or measure, for example the magnitude and/or direction of the force applied by the user to the force receiving element, the position, orientation, velocity, acceleration of the force receiving element, or other non-motion-related data such as the heart rate of the user or ambient noise.

References to a detector herein can all relate to the same detector, which can be provided in the force receiving element, or they can relate to different detectors located in different components of the assembly, for example for detecting or measuring different variables of operation data.

Where components are described herein as being operable to perform a specific function, they are preferably configured to perform that function.

Preferably, the assembly includes a detector which is operable to detect or measure operation data, and the control unit is operable to selectively vary a configuration of the assembly in response to the operation data.

Preferably, varying a configuration of the assembly includes varying a physical arrangement of components of the assembly.

As well as governing the force to be applied by the force application unit, a preferably dynamic algorithm, such as described herein, can also govern the configuration of the assembly and determine how the configuration of the assembly should be varied in response to operation data.

In a preferred embodiment, varying a configuration of the assembly includes varying a direction along which the force application unit is configured to apply a force to the force receiving element. This can be by varying a position of the force application unit, for example on a frame, and/or by varying the position or configuration of a directing unit, such as an intermediary pulley, which the coupling element may include. In this way, in response to the user's behaviour, the assembly is able to change the direction of the force being applied to the force receiving element. In addition, the configuration can be varied in order to avoid the cable being in the way of a user's movement depending upon where the user is located.

The force application unit can be operable to apply a force to the force receiving element in more than one dimension. The force application unit can include first and second force application units operable to apply a force to the force receiving element in first and second directions respectively.

In some embodiments, the assembly can include a plurality of force application units and/or a plurality of force receiving elements. Each of the force application units and/or force receiving elements can be configured with any of the features described throughout this description and accompanying claims. The assembly can be configured such that all force application units are wirelessly linked, thus allowing synchronous operation. In examples, one force application unit can be physically coupled to a plurality of force receiving elements, a plurality of force receiving elements can be coupled to a single force application unit, and/or a plurality of force application units can each be separately coupled to its own force receiving element.

For example, a plurality of force application units being coupled to a single force receiving element can enable that force receiving element to have a force applied to it in more than one direction, thereby enabling a multidimensional variation of force.

For example, a first force application unit can be operable to apply a first force in a first direction and a second force application unit can be operable to apply a second force in a second direction. The control unit can be operable to vary the first and second forces, thereby varying the magnitude and direction of the net force on the force receiving element. Furthermore, the control unit can be operable to vary the directions along which the first and second force application units are configured to apply a force to the force receiving element, thereby to provide greater variation in the direction of the net force.

In addition, a plurality of force receiving elements can enable different limbs to be exercised at the same time, with each limb, or even part of a limb, provided with its own force receiving element.

The or each force application unit is preferably movable. For example, the or each force application unit can be coupled to a frame and the, at least one, or each force application unit or a directing unit for the, at least one, or each force application unit is movable with respect to the frame. This can allow the or each force application unit to be positioned in an appropriate location to apply a force with a desired direction to the force receiving element.

The control unit can be operable to move the or each force application unit or its corresponding directing unit with respect to the frame.

Each of the force application units and force receiving elements can be controlled by the same, or their own, control unit such as described herein.

In some embodiments of the invention, the assembly includes a detector which is operable to determine a position of a user within an exercise space, and the control unit is operable to control the force applied by the or each force application unit to the or each force receiving element in dependence upon the position of the user for example by varying the direction along which the or each force application unit is configured to apply a force to the force receiving element in accordance with an algorithm. The detector can include a scanner such as a 3D scanner.

Preferably, a 3D scanner is able to scan the exercise space and determine the three dimensional position of the user. The 3D scanner is operable to provide this position information to the control unit. The position information obtained by the 3D scanner can be part of the operation data discussed elsewhere, for example for use in calculation of an algorithm governing a force to be applied by the or each force application unit and/or for determining the force to be applied by the or each force application unit.

Being able to determine the position of the user within an exercise space means that the control unit can determine precisely the location of the user, and, in particular, the location of the or each force receiving element or directing unit, in order to assist the control unit in developing an algorithm which is appropriate for the position of the user. This can be of particular advantage in embodiments of the invention where it is desired to limit a force through a particular body part of the user. By having precise knowledge of the force being applied by the user, and precise knowledge of the location of the user relative to the or each force application unit and the size of the user, the control unit can accurately calculate the force through that body part. The control unit can then limit the force applied by the or each force application unit in response to calculating that the force through that body part would exceed the predetermined limit.

Preferably, the force receiving element includes a display operable to provide to a user information relating to a current operation of the assembly. This display can for example be a screen or arrow-shaped lights which can be selectively illuminated. The control unit can operate the display to provide an indication to the user relating to progress through a stroke or how to change his or her current activity to bring it closer in line to a desired exercise.

Preferably, the force receiving element includes an input unit for receiving an input from a user, the input unit being operable to communicate the input to the control unit, for example via the communication unit. In some embodiments, the input unit is a button. The control unit can be programmed to provide a desired functionality to the input unit. In some embodiments, actuation of the input unit causes the control unit to change the scenario code being utilised. In some embodiments, actuation of the input unit causes the control unit to pause operation of the assembly. For example, the control unit can halt application of a force to the force receiving element, for example to allow a user to take a break.

In the event of a user taking a long break, the control unit can adjust the master algorithm to compensate for predicted anatomical changes over the period, for example muscle decay. This can be achieved by the scenario code selecting algorithms to determine an elapsed period and a predicted anatomical change based on attributes of the user and adapting the master algorithm accordingly.

Scenario code can be produced by a method including:
operating a detector to detect or measure calibration operation data relating to a user's operation of the force receiving element;
producing scenario code in dependence upon the calibration operation data.

Scenario code can be produced by a method including:
receiving from a detector calibration operation data relating to a user's operation of the force receiving element;
producing scenario code in dependence upon the calibration operation data.

Scenario codes can be computational code that may be modified to fit a particular user such as for the simulation of the behaviour of ‘free weights’ or a simulation of the behaviour of springs that are slowly stretched. These scenario codes may form the basis of exercise or rehabilitation programs and may be independently modified. For example, if a user desired to use the assembly such that when they retracted and the worked against the re-retraction of a cable it felt as if they had stretched a spring then the aforementioned ‘spring’ scenario code would be employed. All physical parameters of the scenario codes may be manipulated such as the acceleration due to gravity or the spring constant of any spring.

Preferably, to detect or measure calibration operation data, the detector is operated in accordance with calibration stage code. The calibration stage code can operate in a similar manner to the scenario code described elsewhere in this description but is configured to enable the assembly to obtain useful calibration data.

While detecting or measuring calibration data, the assembly can be operated as described elsewhere but with the calibration stage code being used in place of the scenario code.

In embodiments, the step of producing scenario code includes obtaining general code relating to a desired scenario, and producing scenario code from the general code by adapting the general code in accordance with the calibration operation data.

Preferably, obtaining scenario code includes obtaining or receiving identifying data, preferably from the force receiving element, and obtaining scenario code corresponding to that identifying data from data storage.

In some embodiments, an upper limit is provided to the force allowed to be imparted to the user, preferably an upper limit to the force allowed to be imparted to a pre-determined body part of a user.

As described herein, embodiments of the invention provide reliable means of determining precisely the force exerted by a user. In combination with precise calibration, for example by a detector which is operable to determine a position of the user such as described above, embodiments of the invention are able to calculate precisely the force at a particular body part of a user, for example at an injured muscle. This provides particular advantages in the field of injury protection where in the past physicians have been reluctant to prescribe significant regimes of exercise for fear that if the patient overexerted a particular injured muscle, they could exacerbate their condition. Embodiments of the invention allow a scenario code to be tailored to an individual patient to precisely and reliably limit the force in a particular body part. This limit can for example be configured by the physician.

This enables the patient to exercise significantly while still protecting their injury. This can greatly reduce muscle wastage and also increase speed of recovery from such injuries.

In embodiments, the assembly includes a detector operable to detect or measure operation data, wherein operating the force application unit to apply a force to the force receiving element includes selectively varying a configuration of the assembly in response to the operation data.

Preferably, selectively varying a configuration of the assembly includes selectively varying a physical arrangement of components of the assembly and/or selectively varying a direction along which the force application unit is configured to apply a force to the force receiving element.

The method preferably includes obtaining or receiving user-specific data for example relating to a user's physical attributes, operating a detector to measure operation data or receiving operation data from a detector, and operating a control unit to calculate, based on the operation data and user-specific data, the force through a predetermined body part of a user.

In some embodiments, the force receiving element is operable to receive and measure a force applied to the force receiving element by a user and the method includes: a user applying a force to a force receiving element for a period of time; operating the force receiving element to measure the force applied to the force receiving element by the user for the said period of time; analysing the force measured by the force receiving element over the said period of time to diagnose a condition.

In some embodiments, the force receiving element is operable to receive and measure a force applied to the force receiving element by a user and the method includes: receiving from the force receiving element over a period of time data relating to a measurement of a force applied to the force receiving element by the user; analysing the force measured by the force receiving element over the said period of time to diagnose a condition.

As explained above, embodiments of the invention are able to determine precisely the force exerted by a user. This can be used to determine an injury signature and thereby diagnose a condition of a user.

The human body can be viewed as an intelligent, dynamic bio-mechanical device. As such it is advantageous—in order to be truly effective—for a mechanical exercise device to work and interact with the user in an equally responsive/intelligent way.

Prior art solutions are linear and predictive in response to user interaction and the body's requirements thereby ignoring how the human body works.

A human response to a mechanical system cannot be predicted as a human is organic. The body's mechanical properties and its reactions to exercise are highly complex. Prior mechanical exercise devices work to a mechanical setting/limit or are based on a predictive response.

Embodiments of the invention provide an autonomous control system that sits between a user and equipment that allows the user to work with a mechanical system in a bio symbiotic way.

This is advantageous, as it provides a level of autonomous real-time control. Simple feedback loops are acceptable with a single metric (force) but, as is explained herein, single metric feedback is generally an inadequate measure. In this light, real-time monitoring to guide the device's interventions (based upon historic, current and future targets) is an advantageous way to work with the body.

Embodiments of the invention provide a system that works using a number of different metrics and then orders these metrics according to both short (milliseconds/stroke) and long term (hours-years) objectives. The system then processes this data in real-time and adjusts to the user's specific requirements to maximise safety and efficiency.

The system, in embodiments of the invention, ultimately creates an intelligent dialogue between the user and a mechanical device. This dialogue is guided by ultimate objectives as well as historic and real time data sets. In embodiments, the system determines—in real time—the best way to deliver force/resistance to the user.

A problem with prior exercise and rehabilitation regimes and devices is that they do not listen to the body's real time messages. This means that when trying to exercise/recover, they either do not work with the body in fear of causing damage (seen as muscle wastage or negative recovery) or they over-prescribe and cause further short and long term problems. At worst they push the problem around the body creating a new issue altogether. “Most short term knee/ankle damage will be resolved but more often than not, long term lower back pain is created”

A user's physical needs changes over both short (stroke) and long periods of time (recovery/strength and conditioning). Working with a prior device that is predictive assumes that the human body is always the same mechanically and biologically both in its immediate response to exercise and in its long term state/objective.

The user is likely to have a long term goal/objective (hourly-monthly). This might be to recover from an injury, to build strength or improve physical or mechanical technique or simply to improve general conditioning of the body.

In embodiments of the invention, the journey from the body's current state or condition to the goal or objective is not predictive. The journey between the two states is controlled by the short term real time events (stroke) and what has already happened. This data is then mapped onto the required targets and outcomes in order to define how best to meet the goals safely and efficiently.

It should be noted that all prior solutions assume that every stroke/force that any system receives is identical. As such the force all prior systems deliver to the user are the same. What embodiments of the invention do is look at the unique force input as well as the user geometry when determining the best way to reach the objective programmed into the system.

It should also be noted that prior solutions are not designed around a connected system (the musculoskeletal system). Most are designed around a single limb or part of the body. Embodiments of the invention on the other hand are designed around a connected system. Assuming the body will always respond in the same way in isolation is a flawed way to treat a muscle or bone.

Prior solutions only listen and respond to a very small number of metrics (mostly just force) and they always respond in a predictive way. Embodiments of the invention do not function this way and this is advantageous when a mechanical device and biological user are working with each other.

A user has biological and mechanical limits. These limits change continually with every stroke as well as over a longer period. As such to work efficiently with a human system of this complexity, the mechanical device of embodiments of the invention advantageously has an equal or more complex response. If a user has an injury to a muscle, by definition its mechanical and physical properties are different to what its theoretical mechanical limits are. These limits change thousands of times a second and embodiments of the invention can detect these and respond accordingly.

Moreover, the human body is a bio-mechanical device and therefore it is advantageous for a number of metrics to be captured and used to influence the system's interventions.

Taking measurements such as heart rate, body temperature and skeletal position in real time, feeding these back into the system and mapping them over historic data and users' objectives also enables a new level of real-time intervention.

An example of this can be seen in embodiments of the invention when applying a force to an injured body to help recovery. Knowing the precise amount of force to deliver is crucial; too much force will cause more damage, yet too little will not aid recovery. Also note that this force requirement is different when a muscle or limb is fully extended rather than at rest.

Prior systems determine and set a limit which is applied passively to a single metric. In the most advanced form of prior systems a feedback loop is used between a mechanical device and user. However, this still assumes that the limit is a fixed value, when the reality is that it changes in response to short and long term physical properties and mechanical position. Furthermore, this does not take into account the difference in the geometry of every user and the device they are using.

Embodiments of the invention listen to a number of real-time user responses and adapt to the mechanical, biological and physical state of the user. They do this while continually considering both the nature of the short term physical strokes and long term targets. All these different values are then ordered/prioritised depending on each value and the relationship between values. For example, at maximum limb extension muscle limits are more important than bone limits. But these limits are dependent upon the user's geometric position and the type and site of the injury. In embodiments of the invention, the system recognises this and adapts the algorithms accordingly.

The mechanical limit of a bone or the physical limit of a muscle attached to the bone changes constantly so embodiments of the invention advantageously listen to both and respond dynamically.

For example, when a user walks, over 200 muscles are used and the limits and demands are forever changing. If a user wants to improve their walking technique then embodiments of the invention advantageously consider all of the muscles. In order to do this, a number of different metrics are captured in real time via a number of sensor arrays. The key kinematic data is collected and then mapped over historic events and future targets. It is then processed with real time data and delivered back to the user via a number of different devices. Important examples of these are:

1. Force and Direction via motors in both linear and rotational means.
2. Audio and Visual communication with the user to position and instruct him/her in real time via projectors.

This means that over a single stroke embodiments of the invention provide the ability to target all the different muscles used to perform this stroke with different force levels rather than treating a collection of muscles as one. This results in considerable performance benefits.

Conversely, if a user has a strain/tear to a single muscle, this can be highlighted in the interface of embodiments of the invention. The system of embodiments of the invention will prioritise the protection of this muscle in the active algorithm and all other objectives will be superseded.

Furthermore, as a user progresses through a therapy/treatment/workout, their physical and mental energy will become depleted. This in turn will influence the body's limits, the stroke pattern, physical position and response times. In embodiments of the invention, the peak safety values can be monitored and responded to, for example at the end of a workout.

The treatment of knee traumas serves to illustrate another feature of the system of embodiments of the invention. When therapy is started a user has to use each knee differently (healthy vs damaged). The best of the prior solutions have a feedback loop allowing the damaged knee target to be set by the healthy knee. This is only a partial solution as these systems use a predictive target as well as only a single metric feedback loop to monitor both knees.

Embodiments of the invention provide the ability to recognise both knees but also their place within the system as a whole. This is advantageous as without this information people tend to over compensate either on the healthy or damaged knee by shifting the body's geometry. This ultimately manifests itself as long term lower back trauma.

Embodiments of the invention are configured with the knowledge that all human muscle skeletal systems share a fundamental structure but are not identical (embodiments of the invention can even be set up to account for missing muscles or bones). The platform is therefore programmed to continually monitor the huge dynamic variables within the human musculoskeletal system. This enables the system of embodiments of the invention to understand in advance how the user should respond to the force/resistance delivered. This metric is then forced back into the active algorithm enabling a new level of control and intervention.

According to an aspect of the invention, there is provided an assembly for applying a force to a user, including:

a force receiving element for use by a user;
a force application unit operable to apply a force to the force receiving element;
a control unit operable to control the force applied to the force receiving element by the force application unit.

In embodiments, the assembly is for receiving a force applied by a user, and the force receiving element is operable to receive a force applied to the force receiving element by a user.

In embodiments, the force receiving element and the force application unit are distinct components that can be moved relative to each other. Preferably, the force receiving element is operable to detect or measure, preferably directly, a force applied to the force receiving element by a user and the control unit is operable to control the force applied to the force receiving element by the force application unit in dependence upon a force applied by the user as detected or measured by the force receiving element.

In the prior art, a force applied by a user is often inferred from indirect measurements, rather than being actually measured at the point it is being applied. The biomechanical nature of the human musculoskeletal system means for a given force applied to devices in the prior art, the actual forces and movements going on within the body between muscles, tendons and ligaments will significantly differ to the measured quantity. The user often changes position, angle, and so on while applying a force, and these changes can have an effect on the relationship between the force applied by the user, and indirect measurements. In embodiments of the invention, the force applied by the user to the force receiving element is measured directly by the element which receives the user's force, for example by a detector such as a force meter therein. This is able to provide a more accurate measurement of the force actually being exerted by the user, and is therefore able to be used to provide a more reliable assessment of the user's activity.

In embodiments of the invention, the force receiving element is configured to measure a force applied to the force receiving element independently of a force applied by the force application unit. In other words, the assembly does not simply infer the force applied by the user from the amount of force applied to the user. As explained above, the force actually applied by the user may be different from the force applied by the force application unit owing for example to variations in the position of the user or the user's angle of attack.

By being able to measure force applied by the user, embodiments of the invention are able to more accurately monitor a user's progress, as well as being able more appropriately to respond to the user's behaviour. For example, if the assembly has been configured to ensure the user applies a constant force, the user may change position or angle to an extent that the relationship between the force applied by the force application unit and the force the user needs to apply to the force receiving element in response has been changed. In embodiments of the invention, because the assembly can measure the force applied by the user, this change is detected and the force applied by the force application unit can be adjusted accordingly.

In another example, as described in more detail below, embodiments of the invention are able to protect for example an injured user from overexertion by monitoring and limiting the precise force the user is applying. In contrast, this cannot reliably be done where the force applied by the user is only inferred and where it may therefore be inaccurate.

In some embodiments, the force receiving element is movable with the user to enable it to detect or measure multiple aspects of the force applied by the user. For example, the force receiving element can be movable in more than one dimension. Preferably, the force receiving element is movable in any direction in three dimensions.

Measuring the force can refer to measuring just a magnitude of the force, or it can refer to measuring the magnitude and direction of the force.

Controlling a force, as used herein, can include selectively varying the force applied, especially in accordance with pre-determined criteria. For example, it can include varying the position of the force receiving element, for example with respect to a frame. The frame can in some embodiments be part of an everyday object such as a hospital bed.

In some embodiments of the invention, the force receiving element can be a handle which is grasped by the user. The force receiving element can be coupled to the force application unit by a preferably flexible coupling element such as a cable. However, other force receiving elements can be used, and other coupling elements can be used, such as are described below.

In embodiments, the assembly includes a detector operable to measure first, second, and third classes of variables, and the control unit is operable to control the force applied to the force receiving element by the force application unit in dependence upon measurements of the first, second, and third classes of variables; wherein the first, second and third classes of variables relate, respectively, to position, orientation, and kinematic variables, of at least one component of the assembly, such as the force receiving element, or of the user.

In some embodiments, the force receiving element is configured to measure all aspects of motion of the force receiving element.

In embodiments of the invention, the assembly can operate the force application unit to apply a force which is dependent upon a user's past behaviour and preferably also on a user's present behaviour, and preferably also on a scenario code.

In some embodiments, the control unit is operable to control the force applied to the force receiving element by the force application unit in dependence upon an algorithm which can be dependent upon any or all variables of operation data which the assembly is operable to measure.

In embodiments the force receiving element is operable to receive a behavioural input from a user; the control unit is operable to control the force applied to the force receiving element by the force application unit in accordance with an algorithm, the algorithm having a dependency upon the behavioural input; and the control unit is preferably operable during movement of the force receiving element to recalculate the dependency of the algorithm in response to the behavioural input, preferably in response to a change in the behavioural input.

The behavioural input can include one or more variables of operation data relating to a user's behaviour.

The algorithm provides how the assembly is to respond to the user's behaviour.

Embodiments enable the algorithm to be developed over time, and the response of the assembly is thereby affected by past values of operation data.

One particularly advantageous way in which embodiments of the invention develop the algorithm is to develop it under the influence of predetermined guides.

Such embodiments can utilise a general scenario code which encodes a scenario, such as a virtual football, an exercise regime or the like, on a general level. The scenario code can indicate what features and effects are to be employed during use of the assembly.

In embodiments, the assembly includes a detector and:
a) the control unit is operable to obtain scenario code;
wherein, during movement of the force receiving element:
b) the detector is operable to detect or measure first operation data relating to a user's operation of the force receiving element;
c) the control unit is operable to calculate, construct or refine, in dependence upon the first operation data and the scenario code, an algorithm governing a force to be applied by the force application unit;
d) the detector is operable to detect or measure second operation data relating to a user's operation of the force receiving element; and
e) the control unit is operable to operate the force application unit to apply a force to the force receiving element dependent upon the second operation data and the algorithm.

In embodiments, the algorithm provides for calculation of a force to be applied by the force application unit as a function of one or more variables of operation data.

In embodiments, the control unit is operable to configure the function in accordance with the scenario code by calculating one or more parameters of the function in dependence upon the first operation data.

In embodiments, during movement of the force receiving element, the detector is operable to repeatedly detect or measure current operation data relating to a user's operation of the force receiving element, and the control unit is configured to repeatedly calculate from the current operation data and the scenario code, an algorithm governing a force to be applied by the force application unit, and to repeatedly operate the force application unit to apply a force to the force receiving element dependent upon the current operation data and the algorithm.

In embodiments, the repeated calculation of the algorithm includes refining or developing the algorithm using the current operation data and the scenario code.

Accordingly, as new operation data is measured, the algorithm can be changed in dependence on that new data, while keeping the algorithm in accordance with the scenario code.

In this way, there is an almost limitless number of possible algorithms which can affect the force which is applied to the user, and these algorithms are dynamically changeable in response to the user's behaviour.

According to an aspect of the invention, there is provided a force receiving element for an assembly for receiving a force applied by a user and applying a force to a user, the force receiving element including: a detector operable to detect a force applied to the force receiving element by a user; and a coupling mechanism operable to physically couple the force receiving element to a force application unit of an assembly.

Preferably, the detector can detect, and preferably measure, any of the types of operation data discussed above.

According to an aspect of the invention, there is provided a force receiving element for an assembly for applying a force to a user, the force receiving element including:
a detector operable to measure first, second, and third classes of variables; and
a coupling mechanism operable to physically couple the force receiving element to a force application unit of an assembly;
wherein the first, second and third classes of variables relate, respectively, to position, orientation, and kinematic variables.

The force receiving element can in some embodiments be a portable handle which can be connected to an assembly such as described above. In addition, in some embodiments, the force receiving element can be coupled to a conventional assembly such as a system of cable weights.

The force receiving element preferably includes data storage for storing data relating to detections or measurements made by the detector, and/or includes a communication unit which is operable to communicate data detected or measured by the detector to a remote unit such as a data storage device or a control unit of an assembly such as described above.

In preferred embodiments, the user can own his or her own handle which he or she can carry around and attach to exercise machines in order to perform an exercise regime.

The force receiving element can include an identifier for identifying the force receiving element or an associated user; wherein the communication unit is operable to communicate to a control unit of an assembly data relating to the identifier thereby to enable an assembly to identify the force receiving element or a user.

The force receiving element can be operable to communicate the data relating to the identifier in response to the coupling mechanism being coupled to a force application unit.

The identifier can include biometric data relating to a user.

The detector can include one or more of: an accelerometer, a position sensor, an orientation sensor, a velocity meter, and a motion tracker.

Where the exercise machine includes features such as discussed above, the exercise machine can automatically be calibrated to the individual, for example, by the force receiving element communicating the identifier to the control unit of the assembly or to a remote server, which enables the control unit of the assembly to obtain an appropriate scenario code.

Where the exercise machine is a conventional exercise machine, the force receiving element can either store the measured data for later upload to a computer or other device for analysis, or can be communicated to a remote location such as a remote server for example for storage and analysis.

Further advantages of each user possessing their own force receiving elements include that it means that users do not need to share force receiving elements, which has advantages for example in terms of wear on the handles and personal hygiene.

An example of a use of an assembly according to an embodiment of the invention may be if a user uses the assembly to do a deadlift. This would require the cable outlet to be directly under the user so they may pull the force receiving element, in this case a bar, upwards towards the ceiling of the room. It is assumed in this example that the assembly has already been calibrated with the user's strength along the full range of motion to ensure that it will provide a free-weight simulation that will maximally work their muscles. In order to provide this calibration, a calibration stage may be carried out by setting the assembly in a ‘learning’ mode such that the assembly will allow the bar to be lifted at a constant speed regardless of the magnitude of the force applied. A user will be instructed to lift the bar with as much force as is comfortably possible until they have reached what they consider to be the highest point of the bar's motion. At this point, they may stop the retraction or alternatively press a button on the bar. This will begin the inverse process where the assembly will retract the bar at a constant speed and the user must maximally resist this motion. Whilst the above is in process, the control unit will be analysing the forces at all points during this calibration procedure thus calculating the inherent variation in the maximum force the user is able to apply at all points in the stroke. In an injury state, this variation could be extremely pronounced at certain points in the motion. Once this information is known to the control unit for a specific exercise, it may now initiate a scenario code simulating normal ‘free weights’ on a bar that the user may now lift. In this embodiment, this scenario code introduces behaviours such as momentum, and the effects of gravity to as faithfully as possible re-create the feeling of lifting a bar with weights at either end. The difference, however, is that the control unit will add or subtract ‘virtual weights’ from the bar dependent upon the calibration data it has previously obtained from the user at all points throughout the stroke. This will ensure that despite the inherent changing lever moments that the user will be exerting as a result of muscles pulling tendons and thus bones, he or she will always be made to work harder where leverage is such that it should be easier to move the bar and it will be easier at points where leverage is such that it will be harder to move the bar. In the event of a musculoskeletal injury affecting a particular position, this effect will be massively heightened allowing the user to continue to exercise despite this apparent setback. As the user begins to exercise, immediately, orientation sensors will check to see if the bar is level and in the preferred embodiment the user will be constantly scanned to check their posture is correct and that the bar is moving in the correct line to do the exercise safely and effectively. The bar itself may give instructions on any changes to make and at the end of the exercise the user may play back their technique to look for any changes. VR may be used to superimpose the correct line in 3D space so that the user may work to make the bar follow the virtual line in the air. As a result of this scanning the device will be aware of the position of the user at all times and also the kinetics of the movement of the bar and thus will be able to calculate the approximate mechanics at each of the user's individual joints.

According to an aspect of the invention, there is provided a method of operating an assembly for applying a force to a user, wherein the assembly includes a force application unit and a force receiving element, wherein the force application unit is operable to apply a force to the force receiving element; the method including operating the force application unit to apply a force to the force receiving element.

In embodiments, the force application unit and the force receiving element are distinct components that can be moved relative to each other.

In embodiments, the assembly is for receiving a force applied by a user, and the force receiving element is operable to receive and, preferably directly, measure a force applied to the force receiving element by a user, and the method includes receiving from the force receiving element data relating to a force applied by the user to the force receiving element as measured by the force receiving element; and controlling the force applied by the force application unit to the force receiving element in dependence upon the force applied by the user as measured by the force receiving element.

In embodiments, the assembly is for receiving a force applied by a user, and the force receiving element is operable to receive a force applied to the force receiving element by a user, and the method includes receiving a force applied by the user to the force receiving element; operating the force receiving element to measure the force applied to the force receiving element by the user; and controlling the force applied by the force application unit to the force receiving element in dependence upon the force applied by the user as measured by the force receiving element.

In embodiments, the assembly includes a detector operable to measure first, second and third classes of variables, relating respectively, to position, orientation and kinematic variables of at least one component of the assembly or of the user; the method including controlling the force applied by the force application unit to the force receiving element in dependence upon measurements of the first, second and third classes of variables.

In embodiments, the method includes receiving a behavioural input from the user; controlling the force applied by the force application unit to the force receiving element in accordance with an algorithm, the algorithm having a dependency upon the behavioural input; and preferably, during movement of the force receiving element, recalculating the dependency of the algorithm in response to the behavioural input, or in response to a change in the behavioural input.

The method can include:
a) obtaining scenario code;
b) operating a detector to detect or measure first operation data relating to a user's operation of the force receiving element;
c) calculating, constructing or refining, in dependence upon the first operation data and the scenario code, an algorithm governing a force to be applied by the force application unit;
d) operating the detector to detect or measure second operation data relating to a user's operation of the force receiving element; and
e) operating the force application unit to apply a force to the force receiving element dependent upon the second operation data and the algorithm;
wherein steps (b) to (e) are performed during movement of the force receiving element.

The method can include:
a) obtaining scenario code;
b) receiving from a detector first operation data relating to a user's operation of the force receiving element;
c) calculating, constructing or refining, in dependence upon the first operation data and the scenario code, an algorithm governing a force to be applied by the force application unit;
d) receiving from the detector second operation data relating to a user's operation of the force receiving element; and
e) operating the force application unit to apply a force to the force receiving element dependent upon the second operation data and the algorithm;
wherein steps (b) to (e) are performed during movement of the force receiving element.

The method can include, during movement of the force receiving element:

repeatedly measuring or receiving current operation data relating to a user's operation of the force receiving element;
repeatedly calculating, from the current operation data and the scenario code, an algorithm governing a force to be applied by the force application unit; and
repeatedly operating the force application unit to apply a force to the force receiving element dependent upon the current operation data and the algorithm.

In embodiments, the force receiving element is operable to measure a force applied to the force receiving element by a user, the method further including operating the force receiving element to measure a force applied by a user; wherein operating the force application unit to apply a force to the force receiving element includes operating the force application unit to apply a force to the force receiving element in dependence upon the force measured by the force receiving element.

In embodiments, the force receiving element is operable to measure a force applied to the force receiving element by a user, the method further including receiving from the force receiving element data relating to a force applied by a user as measured by the force receiving element; wherein operating the force application unit to apply a force to the force receiving element includes operating the force application unit to apply a force to the force receiving element in dependence upon the force as measured by the force receiving element.

The method preferably includes:
operating a detector to detect or measure operation data;
obtaining an algorithm, wherein the algorithm governs the force to be applied to the force receiving element by the force application unit;
wherein operating the force application unit to apply a force to the force receiving element includes operating the force application unit to apply a force to the force receiving element in dependence on the operation data in accordance with the algorithm.

In embodiments, the method includes:
receiving from a detector operation data;
obtaining an algorithm, wherein the algorithm governs the force to be applied to the force receiving element by the force application unit;
wherein operating the force application unit to apply a force to the force receiving element includes operating the force application unit to apply a force to the force receiving element in dependence on the operation data in accordance with the algorithm.

Computer program codes can be provided to implement for example on a control unit, any of the methods described.

Embodiments of the invention relate to a system for controlling an assembly, a force receiving element and/or an assembly operable to perform the steps of any of the recited methods. In addition, embodiments of the invention relate to methods of using or operating assemblies or devices as described herein.

Embodiments of the invention relate to intelligent resistance control (IRC). The philosophy behind IRC is based upon biomimicry. The system mimics the high level the way in which the brain integrates information from all of its thousands of sensory inputs instantaneously without our knowledge to allow us to carry out precise and intricate movements. With knowledge of the position and kinematics of our limbs, our brain is able to exert a precise level of control on all our motions. IRC recreates this process of analysing positional and kinematic data, giving the user a powerful toolkit for use in diagnostics, rehabilitation and resistive exercise.

Preferred embodiments of the system are able to form a duplex bio-mechanical relationship with the user, able to respond in-sync with the body's natural movements. By allowing greater control of this process, the system opens the door to a level of physical interaction with the body that has never before been seen in a product with applications in so many fields.

Advantages of embodiments of the invention include:
Compact, small-scale cable orientated biodynamic system capable of precisely controlled extension and retraction of the cable.
Form factor allows for convenient device placement in desired location.
Can be integrated with ‘intelligent’ attachment systems or hardware able to augment device usage.
Data may be inputted to device from sensors placed in/on device, sensors in the device-user interface and any data input fields the user will carry out e.g. pre-programming.
With appropriate software, the system may be utilized as a tool kit to carry out a large number of different functions.
Maximises efficiency of workout by working muscles more over the stroke.
Can provide surgical protection, sports simulation, and/or injury prevention normal exercise. Injury prevention normal exercise refers to an option of the assembly simulating a ‘normal’ machine with gravity/momentum and so on but which can be calibrated to reduce the virtual ‘weight’ at certain points.

### Medical Applications

Varying resistance can be calibrated to a patient's specific injury.
Allows exercise, thus rehabilitation, to continue despite angles of flexion causing pain and discomfort.
Visual data and feedback of all processes carried out by the device to maintain various parameters.
Customize data readouts or calculations from various sensors to suit applications.
Feedback about force or speed at all points in the stroke. Able to quantitatively visualize any problems and compare to estimated normal.
Signature pattern of stroke may assist with diagnosis.

### Medical and Exercise Applications

Data may be inputted from GUI thus strokes may be both entirely designed from scratch, and customized by the user, coach or clinical professional.
Intelligent system customised to user's specific needs or rehabilitation program.
Anthropometric data entered into the system either manually or automatically.
Diagnostic—System calculates all forces instantaneously in real time as the device is utilised.
Rehabilitation—A maximum force limit may be placed on a specific structure. Resistance varies appropriately to allow for the maximum safe force at any specific area, thus improving the efficiency of the rehabilitation.
Safeguards against further injury.
May have musculoskeletal research potential.

### Training or Gaming Applications

Real world physical events may be simulated through the cable (e.g. the kicking of a football or striking a tennis ball).
Stroke may be pre-loaded and infinitely customized by user, coach or clinician.
Stroke may be modified to allow speedy rehabilitation whilst safeguarding against injury.
Stroke may be modified to improve performance and muscle memory, allowing intelligent training of athlete.
Stoke may be modified to train athlete by focusing on small areas and improving features of stroke.
Device may be associated with auxiliary hardware creating advanced versions of commonplace exercise devices able to create ultra realistic usage profiles e.g. rowing machine.
Applications in entertainment industry due to simulation capabilities e.g. Nintendo™ Wii™.
1 hub=1 axis (limited to a linear action)
3 hubs=3 axis (full movement in any direction)
Re-create 3D strokes, swings and movements.
Ability to work different muscle groups simultaneously.
3D positioning and movement tracking capability.

### Medical—Physiotherapy and Rehabilitation

The precision and control of a system according to embodiments of the invention means it has great value in the medical field. Specifically suited to musculoskeletal injury rehabilitation, IRC can allow a user to work injured limbs and avoid areas of pain during a stroke or exercise. It can also offer safety and protection during rehabilitation, protecting the user from excessive forces and safeguarding against unwanted set backs or further injury, enabling more efficient recovery. IRC can also act as a key diagnostic tool, giving a physiotherapist or doctor immediate feedback and a data record across the user's recovery program.

### Pro Sport—Advanced Training and Performance

The ability to accurately recreate strokes, swings and actions related to certain sports means that the IRC according to embodiments of the invention can become a powerful tool in professional sport for clubs and athletes. By using the system, weaknesses in an athlete's technique or strength can be highlighted. Strokes or actions can then be customised by a coach to improve technique, strength and muscle memory (e.g. tennis serve). The athlete or coach's progress can be recorded over time and a database of statistical information can be collated to build up a scenario code. In other words, the coach's performance can be used as a base calibration to carry out a more complex simulation to help the user try to adapt to it. However, the user is still able to depart from the coach's behaviour. For example, in a tennis serve, if a user were to wait a little too long before hitting the virtual ball it would be in a different ‘place’ as it would have begun to fall down. Software driving the assembly would take this into account.

### Commercial—Gym and Exercise Equipment

Limitations in current gym and exercise equipment mean that the IRC system according to embodiments of the invention can offer a compact and lightweight solution that can allow for greater control and a range of different exercises/movements from one device. Its dynamic functionality allows workout and strokes to be customised and adapted to the user's needs. A powered return stroke means that muscles may be worked harder than normal resulting in a further increase in exercise efficiency. Graphical feedback also allows the user to visualise their progress and focus on details of their stroke. This data can be recorded so improvement over time can be seen and realistic targets can be set.

### Video Game and Entertainment

The recent success of products such as the Nintendo™ Wii™ and Xbox™ Kinect™ show that motion control gaming is becoming more popular. In embodiments of the invention, IRC's ability to plot a user's 3D position and also simulate movements and strokes mean it can serve as an ultimate control device for physically-interactive gaming and the next level in gaming simulation.

The commercial exercise and fitness markets are saturated with a number of exercise and rehabilitation equipment. The majority of these devices offer limited control and functionality with no feedback. The small number of machines that do offer some level of control and feedback are far less advanced than the IRC system according to embodiments of the invention.

Existing machines are mainly limited by their reliance on passive weights or resistance. This means that they tend to be large and heavy, taking up vital floor space. They are also mostly limited to one type of exercise or stroke meaning more machines are required to suit user's needs.

There are some devices currently used in the medical market for musculoskeletal diagnosis and rehabilitation, but these have limited functionality and poor usability due to their bulky size. These machines are high cost and can only offer basic levels of feedback.

Embodiments of the invention are advantageous as they address many of the issues with existing devices, allowing for greater control, feedback efficiency and safety.

Embodiments of the invention are provided by the following clauses:

1. An assembly for receiving a force applied by a user and for applying a force to a user, including:
a force receiving element operable to receive a force applied to the force receiving element by a user;
a force application unit operable to apply a force to the force receiving element; and
a control unit operable to control the force applied to the force receiving element by the force application unit;
wherein the force receiving element and the force application unit are distinct components that can be moved relative to each other, the force receiving element is operable to measure directly a force applied to the force receiving element by a user, and the control unit is operable to control the force applied to the force receiving element by the force application unit in dependence upon a force applied by the user as measured by the force receiving element.
2. An assembly according to clause 1, wherein the force receiving element is movable in more than one dimension.
3. An assembly according to any preceding clause, including a detector operable to measure first, second, and third classes of variables, wherein the control unit is operable to control the force applied to the force receiving element by the force application unit in dependence upon measurements of the first, second, and third classes of variables; wherein the first, second and third classes of variables relate, respectively, to position, orientation, and kinematic variables, of at least one component of the assembly or of the user.
4. An assembly according to any preceding clause, wherein the force receiving element is operable to receive a behavioural input from a user; the control unit is operable to control the force applied to the force receiving element by the force application unit in accordance with an algorithm, the algorithm having a dependency upon the behavioural input.
5. An assembly according to clause 4, wherein the control unit is operable during movement of the force receiving element to recalculate the dependency of the algorithm in response to the behavioural input.
6. An assembly according to any preceding clause including a detector, wherein:
a) the control unit is operable to obtain scenario code;
wherein, during movement of the force receiving element:
b) the detector is operable to detect or measure first operation data relating to a user's operation of the force receiving element;
c) the control unit is operable to calculate, construct or refine, in dependence upon the first operation data and the scenario code, an algorithm governing a force to be applied by the force application unit;
d) the detector is operable to detect or measure second operation data relating to a user's operation of the force receiving element; and
e) the control unit is operable to operate the force application unit to apply a force to the force receiving element dependent upon the second operation data and the algorithm.
   7. An assembly according to clause 6, wherein, during movement of the force receiving element:
   the detector is operable to repeatedly detect or measure current operation data relating to a user's operation of the force receiving element, and
   the control unit is configured to repeatedly calculate from the current operation data and the scenario code, an algorithm governing a force to be applied by the force application unit, and to repeatedly operate the force application unit to apply a force to the force receiving element dependent upon the current operation data and the algorithm.
   8. An assembly according to any preceding clause, wherein the force receiving element is configured to measure a force applied to the force receiving element by a user independently of a force applied by the force application unit.
   9. An assembly according to any preceding clause, wherein the force receiving element includes a force meter configured to measure a force applied directly to the force receiving element by a user.
   10. An assembly according to any preceding clause, wherein the force receiving element is physically coupled to the force application unit by a coupling element; wherein the coupling element is preferably a cable.
   11. An assembly according to any preceding clause, including a detector operable to measure operation data, wherein the control unit is operable to selectively vary a configuration of the assembly in response to the operation data.
   12. An assembly according to clause 11, wherein the control unit is operable to selectively vary a physical arrangement of components of the assembly in response to the operation data.
   13. An assembly according to clause 11 or 12, wherein the control unit is operable to vary a direction along which the force application unit is configured to apply a force to the force receiving element in response to the operation data.
   14. An assembly according to any preceding clause, including a plurality of force application units.
   15. An assembly according to any preceding clause, including a plurality of force receiving elements.
   16. An assembly according to any preceding clause, wherein the or each force application unit is coupled to a frame, wherein the or each force application unit or a directing unit for the or each force application unit is moveable with respect to the frame.
   17. An assembly according to clause 16, wherein the control unit is operable to move the or each force application unit or its corresponding directing unit with respect to the frame.
   18. An assembly according to any preceding clause, wherein the force application unit is operable to apply a force to the force receiving unit in more than one dimension.
   19. An assembly according to clause 18, wherein the force application unit includes first and second force application units, the first and second force application units being operable to apply a force to the force receiving element in first and second directions respectively.
   20. An assembly according to any preceding clause, including a detector operable to determine a position of a user within an exercise space; wherein the control unit is operable to control the force applied by the or each force application unit to the force receiving element in dependence upon the position of the user.
   21. An assembly according to clause 20, wherein the detector includes a scanner.
   22. An assembly according to any preceding clause, wherein the force receiving element includes a display operable to provide to a user information relating to a current operation of the assembly.
   23. An assembly according to any preceding clause, wherein the force receiving element includes an input unit for receiving an input from a user, the input unit being operable to communicate the input to the control unit.
   24. A method of operating an assembly for receiving a force applied by a user and for applying a force to a user, wherein the assembly includes a force application unit and a force receiving element, the force application unit and force receiving element being distinct components that can be moved relative to each other, wherein the force application unit is operable to apply a force to the force receiving element and the force receiving element is operable to receive and directly measure a force applied to the force receiving element by a user; the method including:
   operating the force application unit to apply a force to the force receiving element; receiving from the force receiving element data relating to a force applied to the force receiving element by the user as directly measured by the force receiving element; and
   controlling the force applied by the force application unit to the force receiving element in dependence upon the force applied by the user as measured by the force receiving element.
   25. A method according to clause 24, wherein the assembly includes a detector operable to measure first, second and third classes of variables, relating respectively, to position, orientation and kinematic variables of at least one component of the assembly or of the user; the method including controlling the force applied by the force application unit to the force receiving element in dependence upon measurements of the first, second and third classes of variables.
   26. A method according to clause 24 or 25, including receiving a behavioural input from the user; controlling the force applied by the force application unit to the force receiving element in accordance with an algorithm, the algorithm having a dependency upon the behavioural input.
   27. A method according to clause 26, including, during movement of the force receiving element, recalculating the dependency of the algorithm in response to the behavioural input.
   28. A method according to any of clauses 24 to 27, including providing an upper limit to the force allowed to be imparted to a predetermined body part of a user.
   29. A method according to any of clauses 24 to 28, wherein the assembly includes a detector operable to measure operation data, wherein operating the force application unit to apply a force to the force receiving element includes selectively varying a configuration of the assembly in response to the operation data.
   30. A method according to clause 29, wherein selectively varying a configuration of the assembly includes selectively varying a direction along which the force application unit is configured to apply a force to the force receiving element.
   31. A method according to any of clauses 24 to 30, including:
a) obtaining scenario code;
b) receiving from a detector first operation data relating to a user's operation of the force receiving element;
c) calculating, constructing or refining, in dependence upon the first operation data and the scenario code, an algorithm governing a force to be applied by the force application unit;
d) receiving from the detector second operation data relating to a user's operation of the force receiving element; and
e) operating the force application unit to apply a force to the force receiving element dependent upon the second operation data and the algorithm;
wherein steps (b) to (e) are performed during movement of the force receiving element.
   32. A method according to clause 31, including, during movement of the force receiving element:
   repeatedly receiving current operation data relating to a user's operation of the force receiving element;
   repeatedly calculating, from the current operation data and the scenario code, an algorithm governing a force to be applied by the force application unit; and
   repeatedly operating the force application unit to apply a force to the force receiving element dependent upon the current operation data and the algorithm.
   33. A method according to clause 31 or 32, wherein obtaining scenario code includes receiving identifying data, preferably from the force receiving element, and obtaining scenario code corresponding to that identifying data from data storage.
   34. A method according to any of clauses 24 to 33, including receiving user-specific data, receiving from a detector operation data, and operating a control unit to calculate, based on the operation data and user-specific data, the force through a predetermined body part of a user.
   35. A method according to any of clauses 24 to 34, wherein the force receiving element includes a display, the method including operating the display to provide to the user information relating to a current operation of the assembly.
   36. Computer program code operable when executed on a programmable device to perform the method of any of clauses 24 to 35.

It is to be appreciated that certain embodiments of the invention as discussed herein may be incorporated as code (e.g., a software algorithm or program) residing in firmware and/or on computer useable medium having control logic for enabling execution on a computer system having a computer processor. Such a computer system typically includes memory storage configured to provide output from execution of the code which configures a processor in accordance with the execution. The code can be arranged as firmware or software, and can be organized as a set of modules such as discrete code modules, function calls, procedure calls or objects in an object-oriented programming environment. If implemented using modules, the code can comprise a single module or a plurality of modules that operate in cooperation with one another.

Preferred embodiments of the invention are described below, with reference to the accompanying drawings, in which:

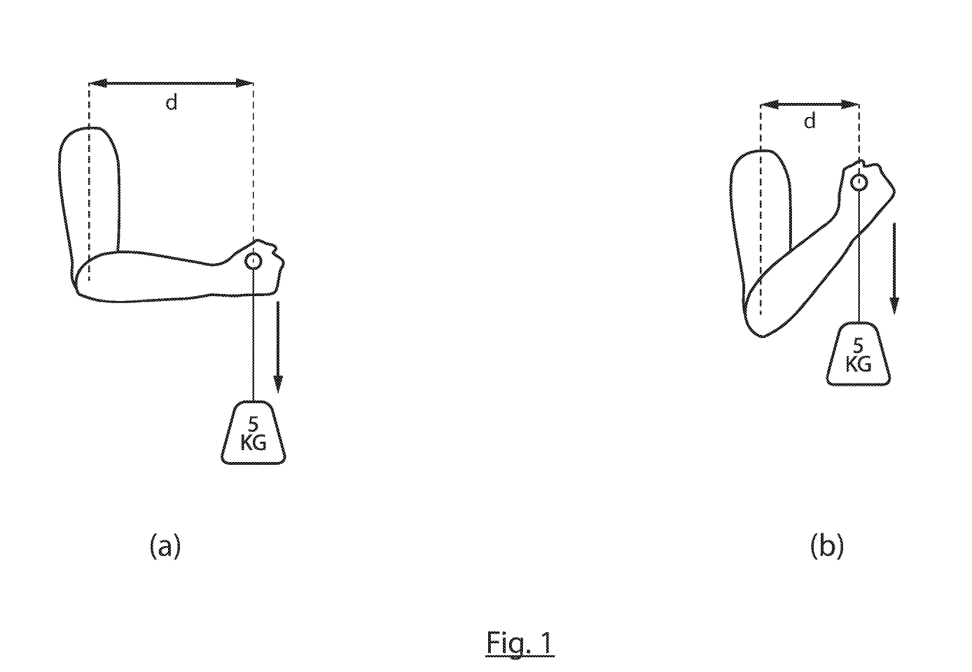

FIGS. 1 (a) and (b) are schematic diagrams of a known exercise assembly;

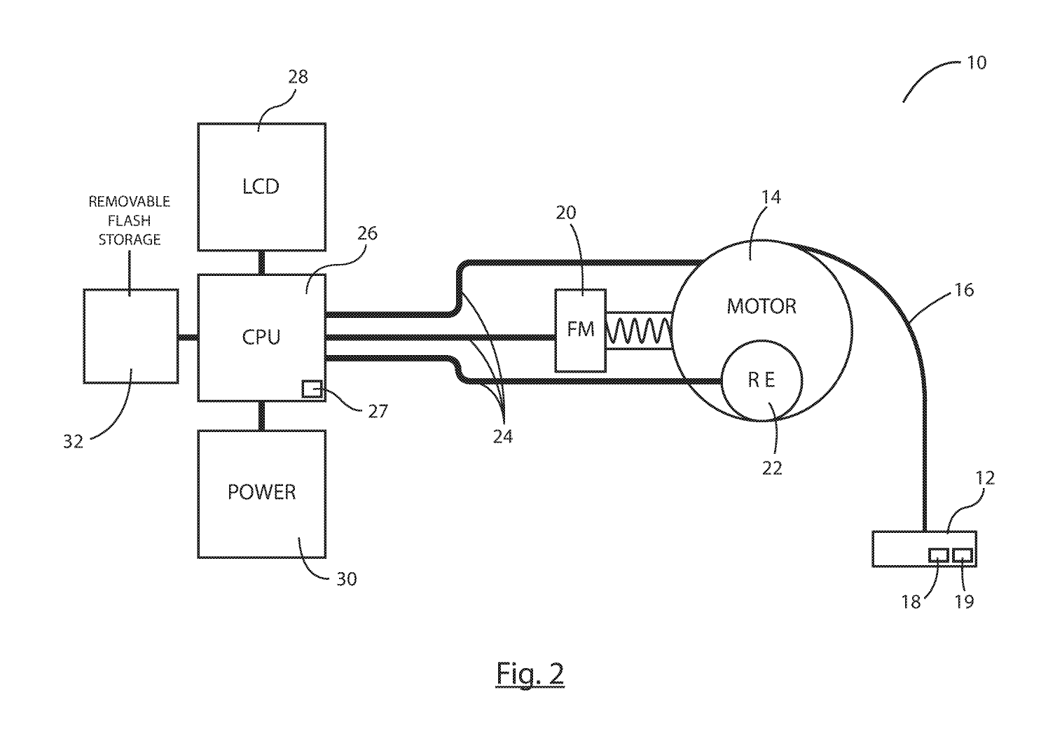

FIG. 2 is a schematic diagram of an assembly according to an embodiment of the invention;

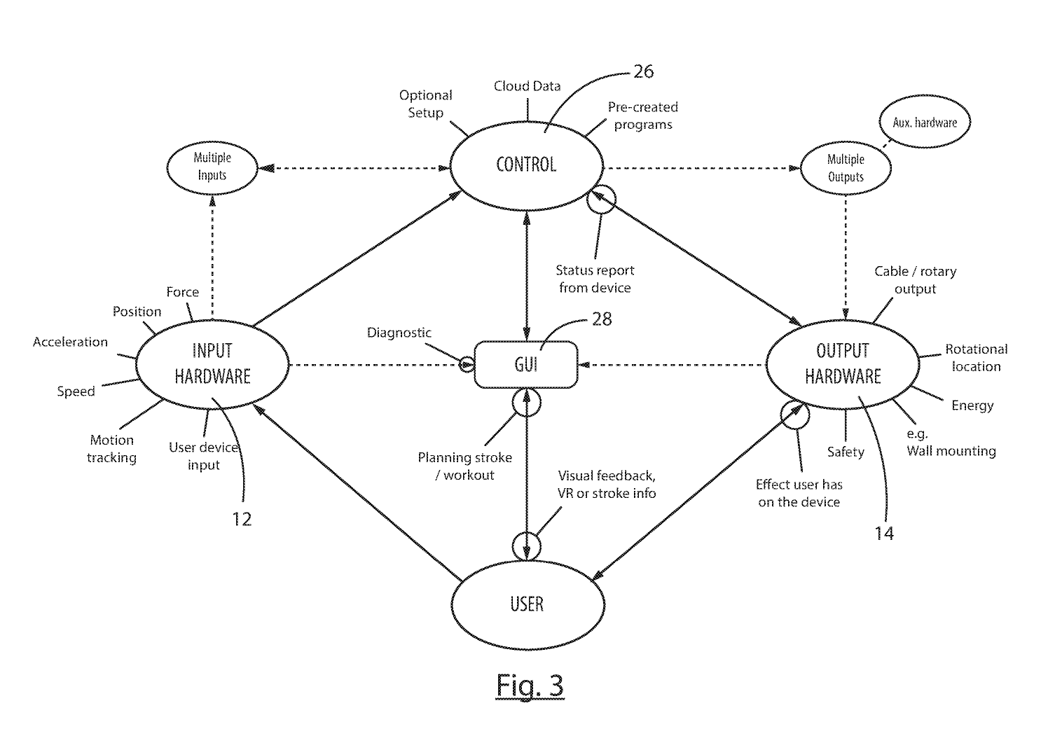

FIG. 3 is a schematic system diagram of the assembly according to the embodiment of FIG. 2;

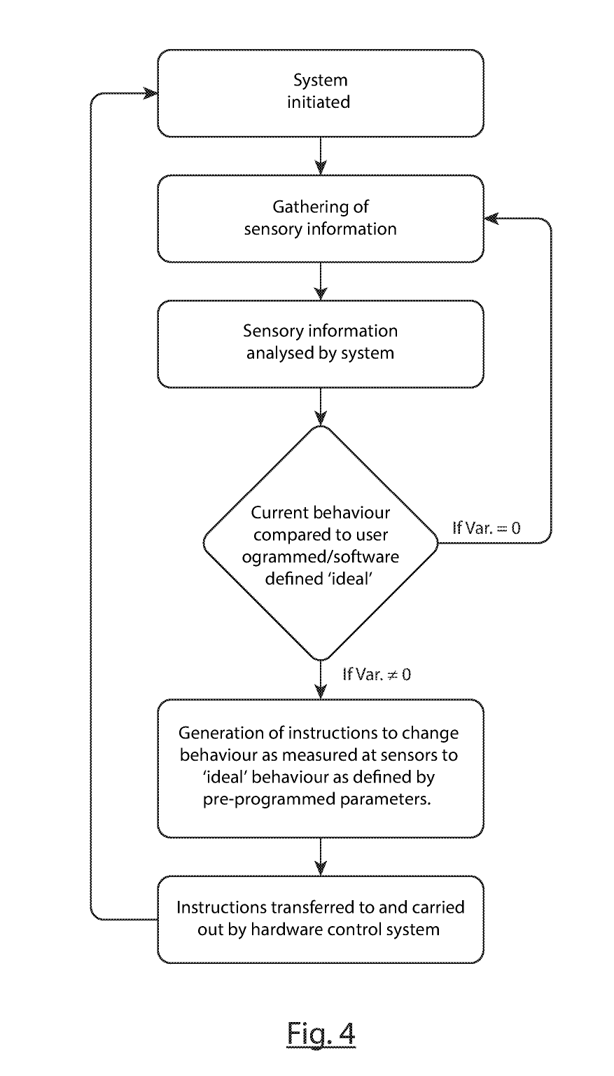

FIG. 4 is a flow chart of a method according to an embodiment of the invention;

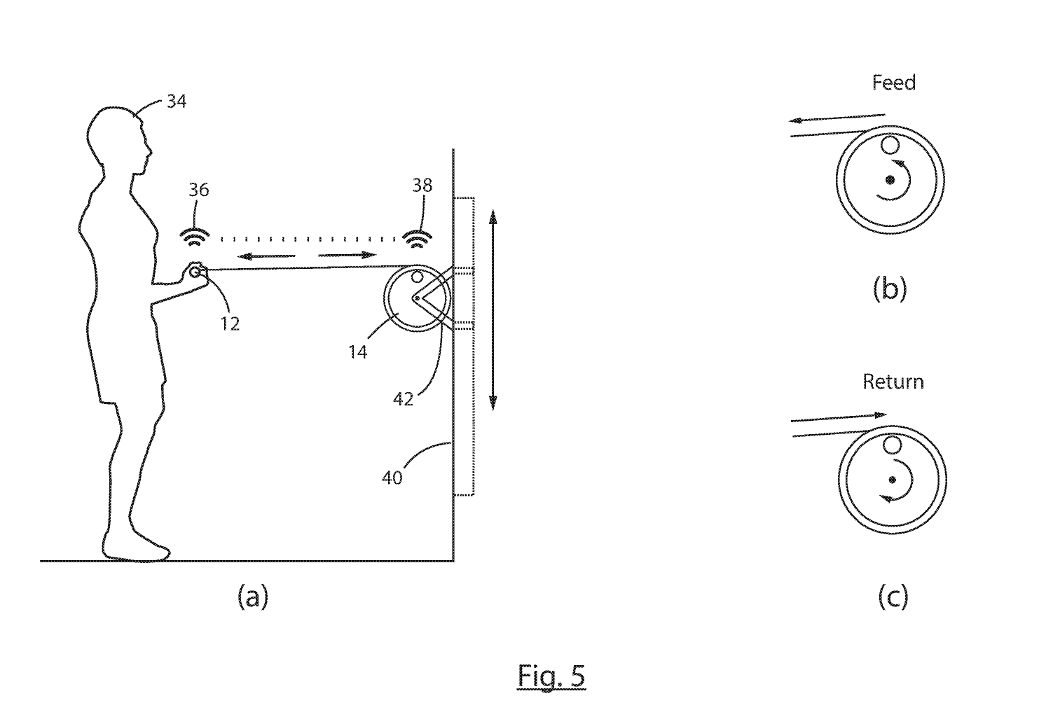

FIGS. 5 (a), (b) and (c) are schematic diagrams of the assembly according to the embodiment of FIG. 2 in use;

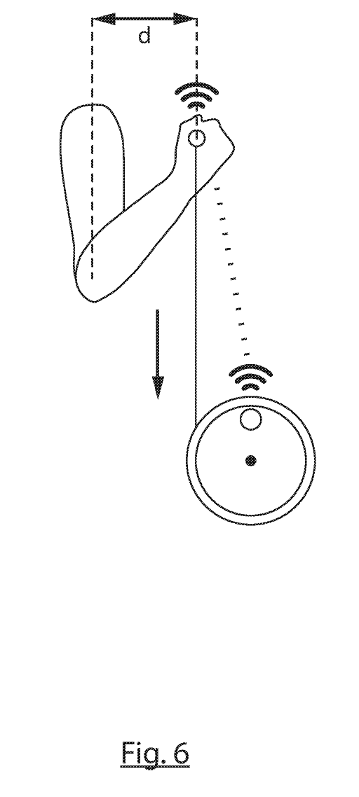

FIG. 6 is a schematic diagram of the assembly according to the embodiment of FIG. 2 in use;

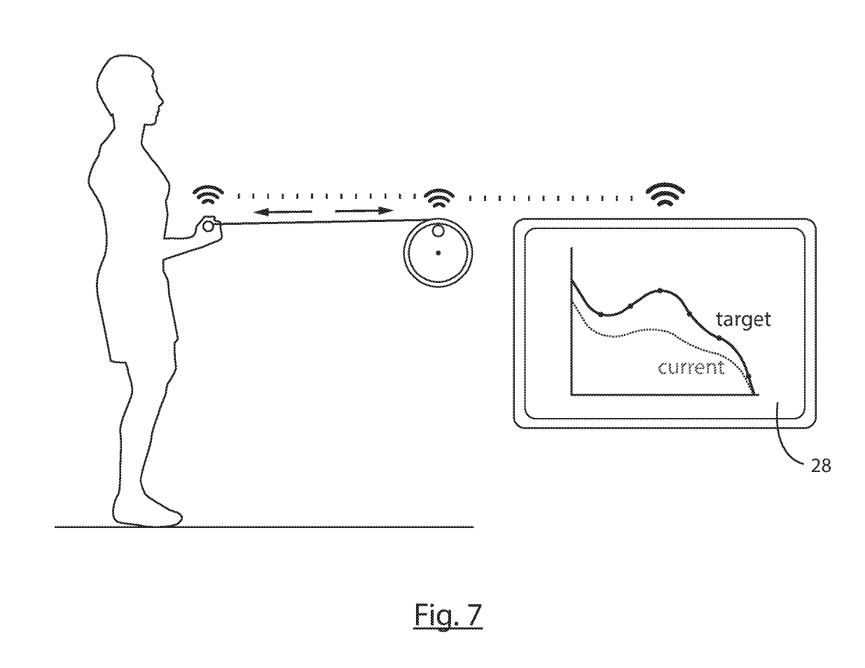

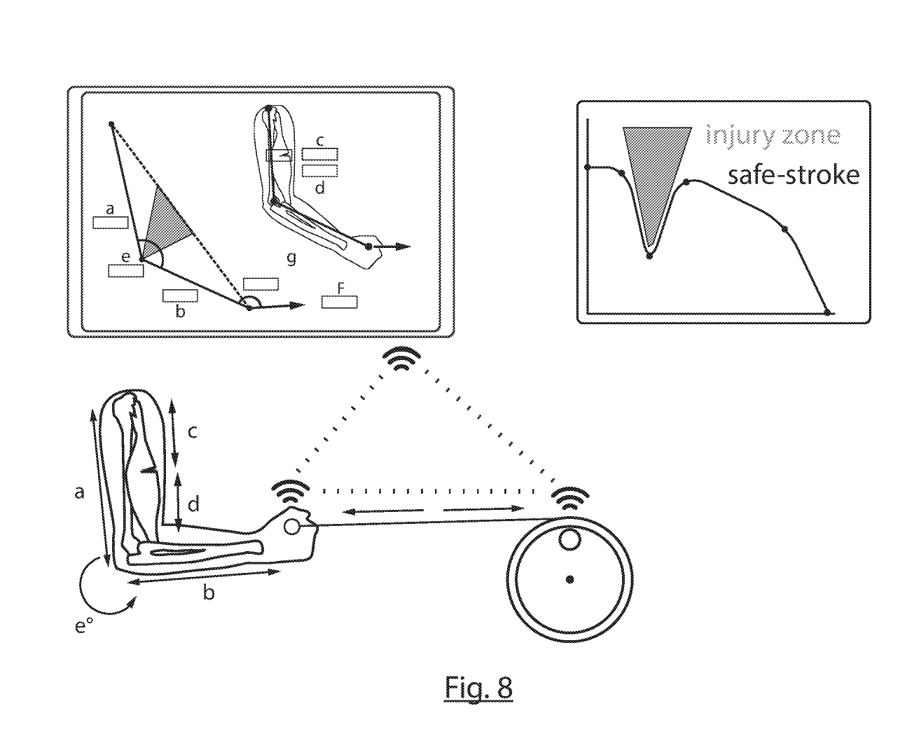

FIGS. 7 and 8 are schematic diagrams of the assembly according to the embodiment of FIG. 2 in use;

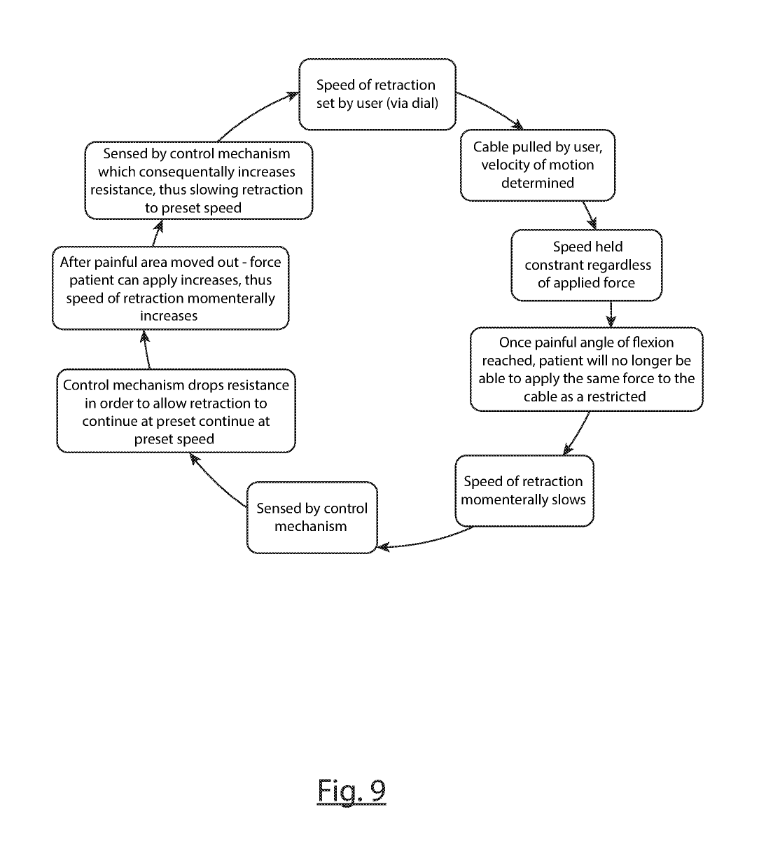

FIG. 9 is a flow chart of a method according to embodiment of the invention;

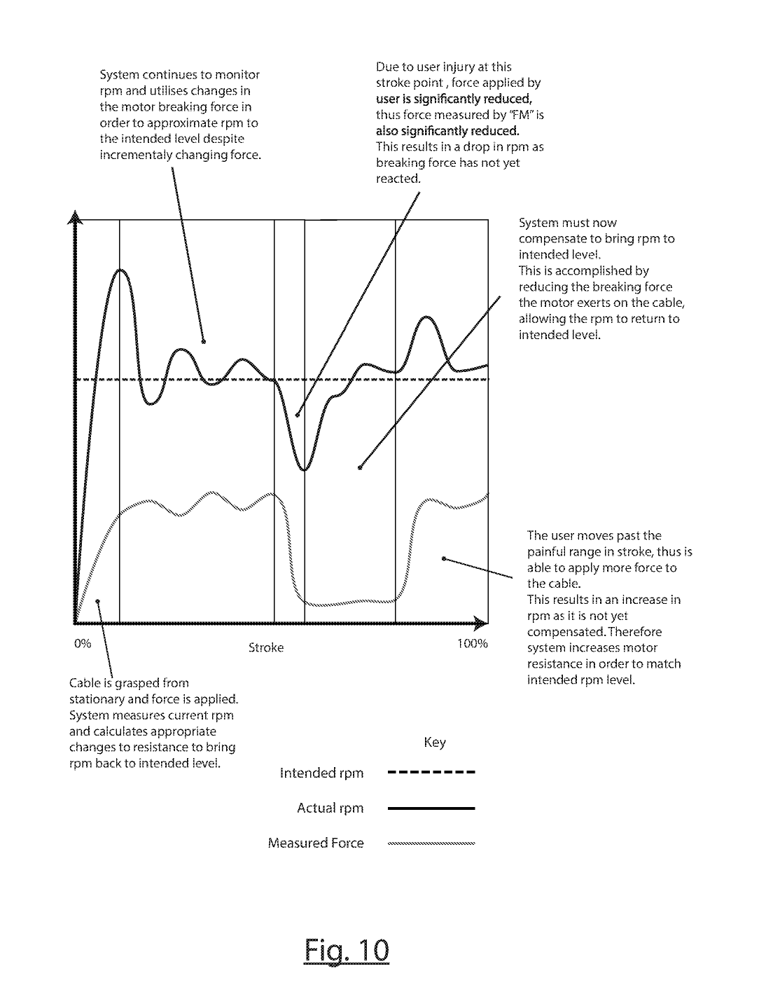

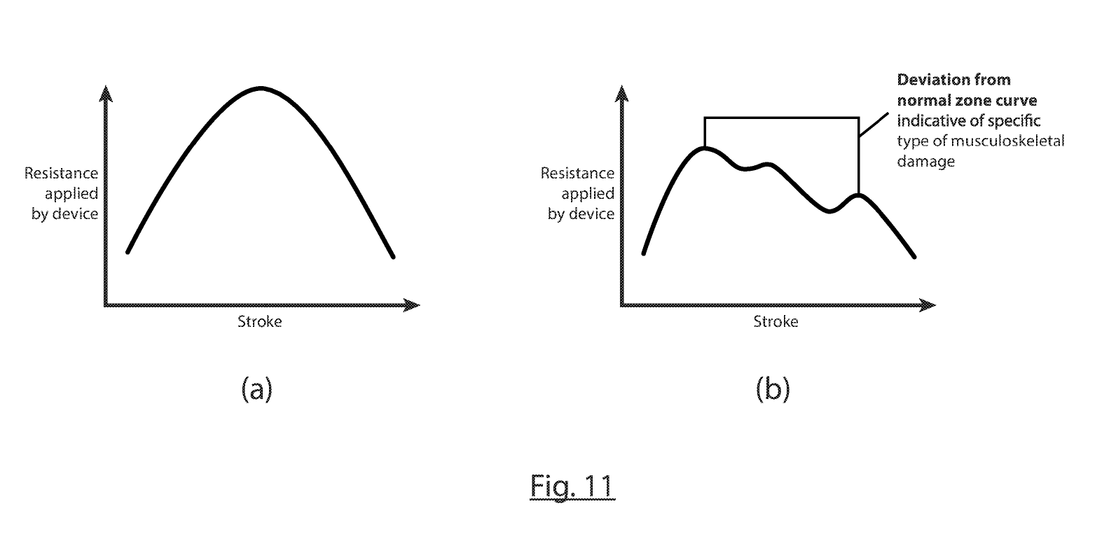

FIGS. 10 and 11 are explanatory graphs relating to the method of the embodiment of FIG. 9;

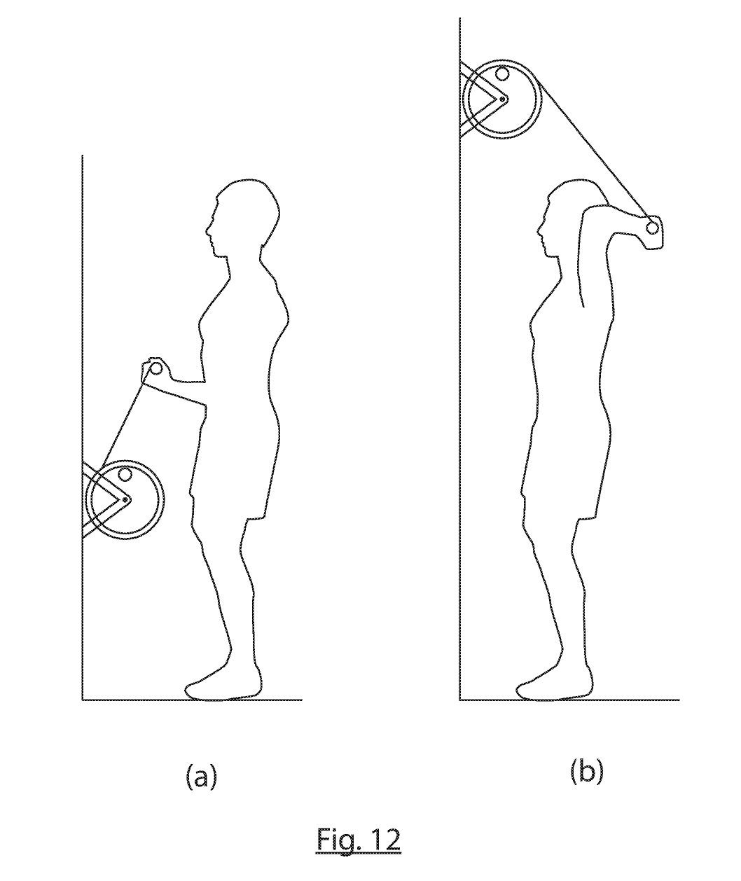

FIGS. 12, 13 and 15 are other arrangements for the assembly of FIG. 2;

FIGS. 14 and 16 to 19 show assemblies according to other embodiments of the invention;

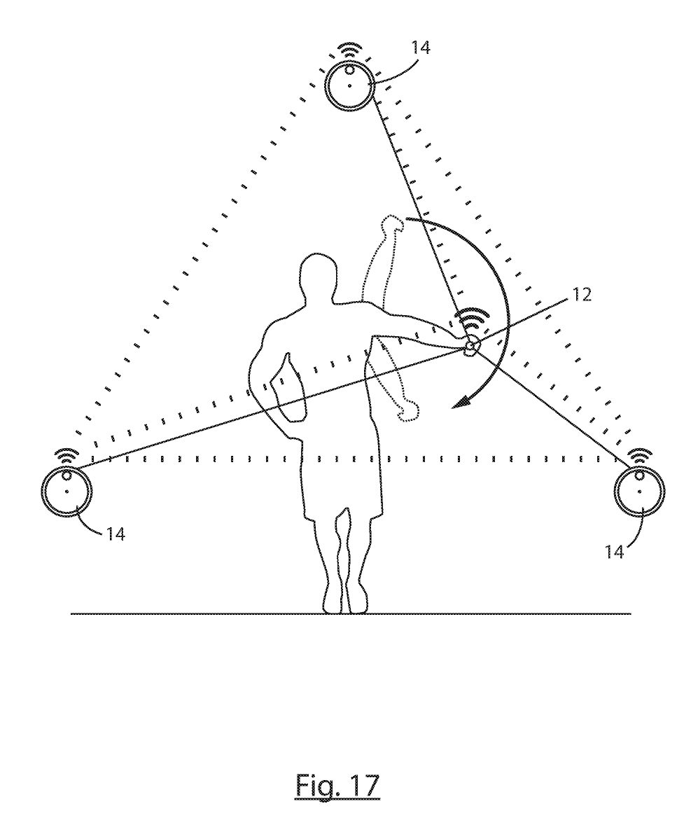

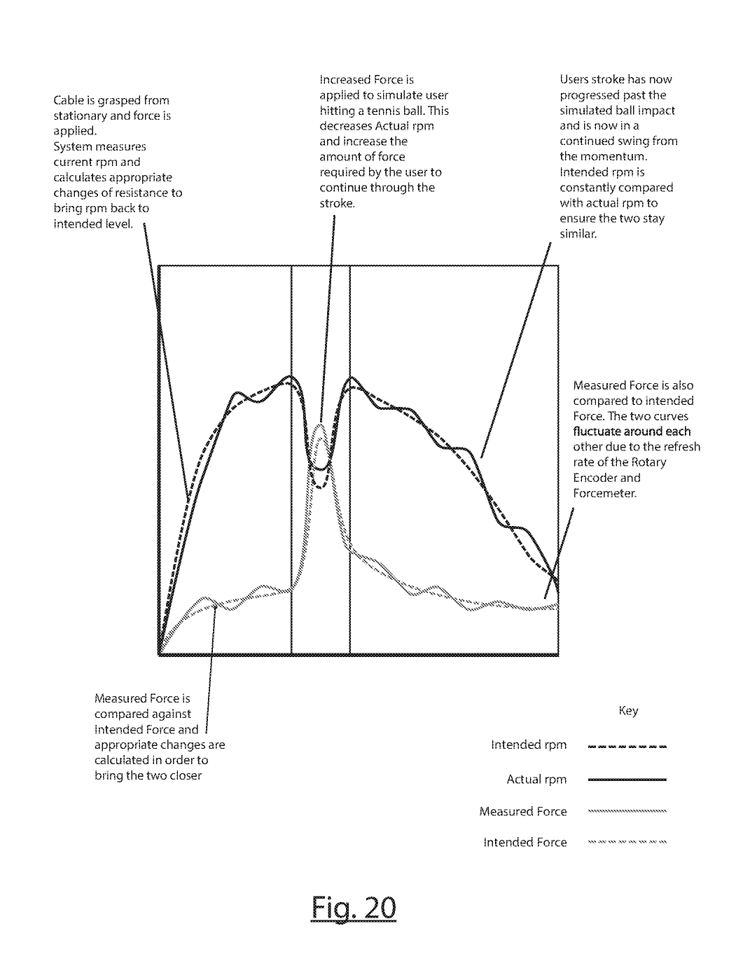

FIG. 20 is a graph relating to the embodiment of FIGS. 17 to 19;

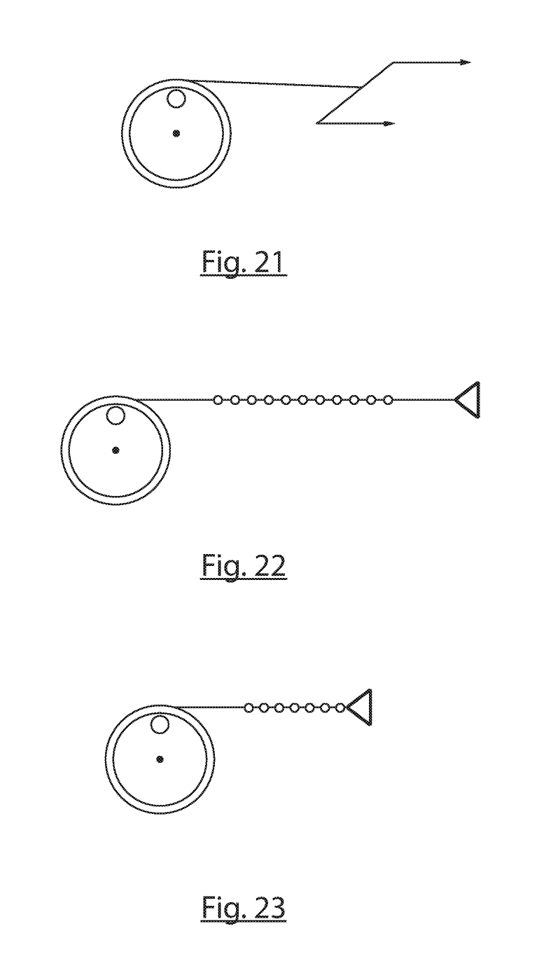

FIG. 21 is a schematic diagram of an assembly in which operation data can be measured from first and second ends of a force receiving element;

FIGS. 22 and 23 are schematic diagrams showing how a cable can be illuminated according to embodiments of the invention;

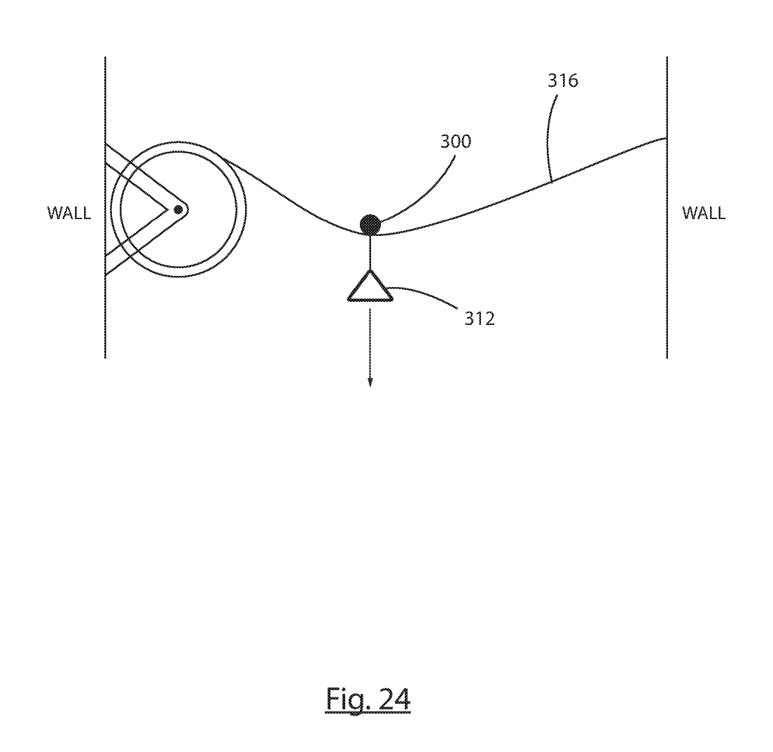

FIG. 24 is a schematic diagram of an assembly according to an embodiment of the invention; and

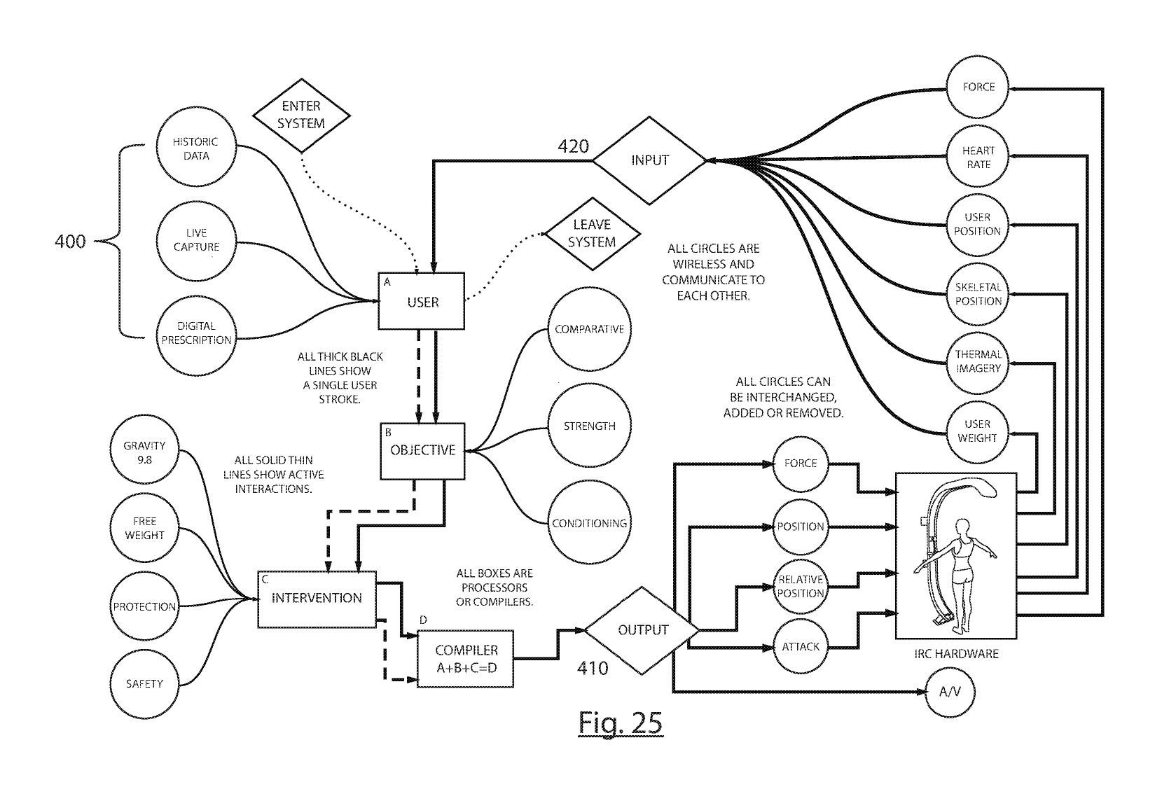

FIG. 25 is a schematic diagram illustrating operation of an assembly according to an embodiment of the invention.

FIG. 1 shows the use of a well-known exercise system using a static weight. In this system, the user exercises his arm by raising and lowering the weight as shown. However, as can be seen in FIG. 1 the perpendicular distance from the force to the pivot (marked as d in the Figure) changes with the position in the stroke. Accordingly, such a system does not produce the same force over the whole stroke. The moment changes with the position through the stroke, despite there being a constant weight.

As explained in detail below, preferred embodiments of the invention provide improvements over the system of FIG. 1 in that in embodiments of the invention the force that the user needs to exert is dynamic and can be dependent on various factors, such as the position in the stroke. This can for example enable the system to be tailored to the user so that the user is putting in the maximum effort at all points of the stroke (despite this maximum effort changing throughout the stroke). In this example, as explained below, a calibration stroke can be implemented based on a constant velocity system. Information from the calibration stroke is then integrated into the simulation of a conventional free-weights stack so that the assembly ensures that the user is lifting their maximum load at all points. Naturally this load will decrease as the user tires. The machine can add and remove weights to and from this virtual stack. An important feature of this is if the user were to stop pulling the cable, the assembly will still be exerting a force as it will be simulating some weights hanging off the end of a cable.

### System

Reference is made to FIG. 2 which shows a schematic diagram of an assembly 10 according to an embodiment of the invention. The assembly is for receiving a force applied by user and for applying a force to a user.

The assembly 10 includes a force receiving element 12. In FIG. 2, the force receiving element 12 is a handle which can be gripped by a user's hand. However, as is clear from the description below, the force receiving element 12 can in other embodiments be of different designs and does not necessarily need to be gripped by a user's hand; it can receive a force from a user's foot for example. Nevertheless, the force receiving element 12 is operable to receive and measure a force applied to the force receiving element by a user. In embodiments described below, it can for example include a handgrip, a boot, a long bar, a racket, a leg cuff, or other element by which a user can apply a force to the assembly.

The assembly 10 includes a force application unit 14 which is operable to apply a force to the force receiving element 12. The force application unit is physically coupled to the force receiving element 12 by a coupling element 16. In the embodiment of FIG. 2, the coupling element 16 is a flexible cable. However, other means of physically coupling the force receiving element 12 to the force application unit 14 are possible, provided they are able to convey a force applied by the force application unit 14 to the force receiving element 12 and preferably also able to convey to the force application unit 14 a force applied by a user to the force receiving element 12.

As described above, the force application unit 14 is operable to apply a force to the force receiving element 12. In the embodiment of FIG. 2, the force application unit 14 includes an electromagnetic motor and a pulley, and the cable 16 is attached to the pulley. The force application unit 14 is operable to apply a force to the force receiving element 12 by the motor applying a force to the pulley attempting to reel in the cable 16 around the pulley. The force application unit 14 is also operable to apply an electromagnetic breaking force to the pulley which would provide a resistance force against any force applied by the user attempting to unreel the cable 16 from the pulley.

Although the embodiment of FIG. 2 uses an electromagnetic motor and pulley, other types of force application unit can be used instead of or in addition provided that the force application unit is operable to apply a force to the force receiving element.

The force receiving element 12 includes a detector 18 which is operable to take measurements relating to a force applied to the force receiving element 12 by a user. The detector 18 can directly measure a force applied to the force receiving element by a user. It may also measure other operation data such as the acceleration, position, velocity, orientation, or other operation data associated with a user's application of a force to the force receiving element 12. The operation data may also include other parameters not to do with force such as heart rate or ambient noise such as music. In some embodiments, the assembly can change current behaviour depending on the music playing.

The design of the force receiving element may influence sensors included in the detector. For example, a rowing machine handle may have orientation sensors to detect positional data.

The detector 18 is configured to measure a force and other operation data, such as described above, related to the force applied to the force receiving element 12 by a user independently of any force applied by the force application unit 14. The detector 18 may include a force meter, a velocity meter, an accelerometer, an orientation sensor, and/or other detector operable to detect and measure the relevant operation data.

The assembly may include ‘stick on’ ultrasound transducers which can be attached for example to a wrist, elbow and/or shoulder of a user. The transducers can be detected and measured by a detector such as the detector 18. With these transducers, the detector can determine the spatial orientation of the force application unit relative to a vector force direction measured by an accelerometer of the detector 18. This is an efficient way to input position information without any calibration needed. A user can simply put on a ‘suit’ with these transducers embedded in it.

The spatial position of a user can also or alternatively be measured by a 3d scanner such as described in more detail below.

In some embodiments, the assembly can be calibrated by inputting an approximate start and end point. This can for example be done manually.

The force receiving element 12 includes a communication unit 19 which is operable to communicate data detected by the detector 18 to a corresponding communication unit 27 of a control unit 26. The control unit 26 is described in more detail below. The communication unit 19 may be a wireless communication unit, such as a Wi-Fi or Bluetooth enabled unit, or may be coupled to the communication unit 27 of the control unit 26 via a physical coupling, for example through a wire within the cable 16.

In the embodiment of FIG. 2, the force receiving element 12 includes personally identifying information such as biometric information. When the force receiving element is coupled to the force application unit, the communication unit is operable to communicate this personally identifying information to the control unit 26, such as to make clear to the control unit what force receiving element or periphery device is currently attached.

In the embodiment of FIG. 2, the force receiving element is detachable from the force application unit. This can mean that each individual can own their own force receiving element and can connect it to a force application unit before beginning their exercise. As described below, in response to a force receiving element with personally identifying information being connected, the assembly can obtain a personal exercise regime for that individual without the individual needing to input anything further.

In some embodiments, the force receiving element can be connected to the force application unit by a force limited connector. The force limited connector comprises a first part connected to the force application unit and a second part connected to the force receiving element. The first and second parts are connected together. The force limited connector is configured so that it will only maintain the connection between the first and second parts up to a threshold force. Forces greater than the threshold force will cause the first and second parts to separate. Such a connector can be used to limit the maximum force than can be applied to the user. Advantageously, the threshold force can be varied, for example where the connection between the first and second parts is maintained by an electromagnetic force application unit. However, it is to be noted that the force limited connector is in general auxiliary user protection which is only used in the event of a main system failure.

The force application unit 14 includes a force meter 20 which is operable to detect a force applied to the force application unit by the force receiving element 12. In the embodiment of FIG. 2 the force meter 20 is solid state, and is able to provide force readings accurately within the weight range of the assembly.

The force application unit 14 also includes a rotary encoder 22 which is operable to determine the position within a stroke at which the pulley is located. During a stroke, the force receiving element 12 moves from a minimum displacement from the force application unit 14, to a maximum displacement, and back to a minimum displacement. The term stroke is used herein to refer to a complete cycle of this process, although the starting point does not necessarily need to be at a minimum displacement. A stroke can start at any point. For example, a stroke can be from a maximum displacement of the force receiving element, to a minimum displacement, and back to a maximum displacement. In the embodiment of FIG. 2, the maximum and minimum displacements can be, respectively, the cable being fully extended and the cable being fully wound onto the pulley. However, the maxima and minima do not need to be full, but can be partial, extensions and retractions of the cable.

In the embodiment of FIG. 2 the rotary encoder 22 can determine the position within a stroke by determining the number of degrees through which the pulley has rotated. In other embodiments of the invention, other means of determining the position within a stroke are provided.

The force meter 20 and the rotary encoder 22 are coupled to the control unit 26 by a coupling 24. The coupling 24 also couples the control unit 26 to the motor of the force application unit 14. In the embodiment of FIG. 2, the coupling 24 is shown as being a physical wired coupling. However, it can alternatively be a wireless coupling such as described in respect of the communication unit 19. For example, the control unit can be a remote server that receives data from the force receiving element and the force application unit, and which remotely controls the motor of the force application unit.

The force meter 20 and the rotary encoder 22 are operable to communicate to the control unit 26 operation data which they have measured relating to the force application unit 14. The control unit 26 is operable to control via the coupling 24 the force applied by the motor of the force application unit.

The control unit 26 may be a computerised processor, such as a CPU of a personal computer, programmed with a suitable computer program. It may be coupled to a source of power 30 such as a battery or a mains power supply. It may also be provided with a display 28 such as a liquid crystal display operable to provide a graphical user interface (GUI). However, the display 28 does not need to be physically coupled to the control unit 26. The display 28 can be provided on a separate device from the control unit 26, wherein the device that includes the display 28 is operable to communicate with the control unit 26. For example, the display 28 can be the display of a personal device such as a smart phone or a tablet computer.

The control unit 26 may also include a memory 32 such as a removable flash storage. Alternatively, or in addition, the memory 32 may be at a remote location.

The control unit includes, for example in the memory 32, a library of many pre-programmed algorithms or ‘interventions’. Many or all of these are configurable. An ‘intervention’ is a discrete program which may be an individual control program (as an example, an intervention might be a program that adjusts resistance based on current heart rate. Alternatively, another intervention might be a program that works to ascertain the maximum power output of a specific muscle group or yet another intervention may work to find and expand the range of movement of a specific muscle group. Yet another one could be a profile generation algorithm).

Interventions can affect an output of the assembly, such as the force applied by the force application unit, or the configuration of the assembly, and can affect the output of the assembly in dependence on operation data. For example, some interventions can provide a relationship between a force to be applied by the force application unit and any number of variables of operation data or results of calculations made on operation data. For example, some interventions can provide a force to be applied by the force application unit as a function of one or more variables of operation data. Interventions can perform calculations on operation data and provide those calculations as an output which can be used by another intervention, or use the calculations to configure another intervention. As described above, many or all of the interventions are configurable in order to be configured from a general type of algorithm into an algorithm that is tailored to an individual user. Some of the interventions are configuring interventions. Configuring interventions are interventions that can affect the configuration of other interventions. The configuring interventions can themselves be configurable.

Interventions may affect either or both of the input and output of the assembly both together or independently. For example, a specific intervention may correlate a specific set of data inputs with data outputs. An alternative intervention may specify a specific calculation based on a number of different inputs to provide a general variable. This general variable may be used to influence a number of other interventions purely concerned with outputs. Certain interventions may purely be concerned with linking other interventions together. (for example an intervention describing the relationship between muscular stretching and strengthening. This intervention may link up interventions defining strengthening in combination with interventions that influence musculoskeletal stretching.) The control unit can include a physics engine and can be configured with some basic principles about general human anatomy and physiology.

The detector 18, the force meter 20 and the rotary encoder 22 all have a high refresh rate and are operable to communicate their data to the control unit 26 at high refresh rate, or are interrogated by the control unit at a high refresh rate, in response to which they provide data. For this reason, the control unit 26 includes a processor which is fast enough to keep up with this high refresh rate. The control unit 26 also may include space for extra inputs as further functions are added.

In the embodiment of FIG. 2, the control unit is operable to control the electrical resistance between terminals of the motor of the force application unit 14 with a high accuracy and refresh rate in order to provide resistance to a user pulling the force receiving element 12.

In addition, the force application unit is operable to pull the cable 16 against the force the user is applying to the force receiving element 12. In order to do this, the control unit is operable to vary the current and/or voltage to the motor of the force application unit.

In one embodiment, the pulley has a maximum RPM of 500. It is also possible to use two motors to ensure no latent effect between calculations and retractions. For example, one motor can be for extension and one for retraction, meaning there is no lapse in power while a motor changes direction.

FIG. 3 is a schematic system diagram of the assembly of FIG. 2. As can be seen from FIG. 3, the control unit 26 receives data from the force receiving element 12. At the same time, it is controlling the force application unit 14. The control unit is also operable to store, for example in the memory 32, for analysis or review, operation data relating to the user's use of the assembly. As described above, this operation data is received from the force receiving element and the force application unit.

In response to data received from the force receiving element, the control unit 26 is operable to vary the force applied to the force receiving element by the force application unit.

The manner in which the control unit varies the force applied to the force receiving element is itself controllable.

In general, the control unit is provided with or is operable to obtain scenario code. This is typically from a user's input.

The scenario code encodes a virtual environment or a layout of or an objective for an exercise to be performed using the assembly. It governs, as is explained below, how the assembly operates on a general level. It provides a virtual environment or an overarching goal for the user to achieve.

As an example, for a personalised weight-lifting scenario, the scenario code can provide details such as the force required at different points of the stroke, the curve that the user should follow while performing the stroke, how gravity should affect the virtual weights, how the inertia of the virtual weights should cause an effect in response to sudden changes, how the assembly should respond if the user is not following an optimum curve.

As explained above, the assembly can be configured to measure a large amount of operation data of a variety of types, such as force, position, orientation etc. Each of the different types of data can be considered to be different variables.

The control unit is operable to determine what individual interventions and configurations are necessary to allow the user to comply with the scenario code. Interventions may be used in isolation or in any combination.

Initially, before much or any operation data has been measured, the control unit can select from the library one or more configurable interventions in dependence on the scenario code without dependence on operation data. In addition to the one or more configurable interventions, the control unit can select one or more non-configurable interventions. Interventions may be selected using pre calibrated information about usual human anatomy and physiology however at this point it is non specific to a user. There may be some unknown variables that the processor does not currently know that are required for some or all of the selected interventions.

As operation data is gathered, the control unit is operable to configure the selected configurable interventions in dependence on the scenario code and operation data. For example, the control unit can select from the library one or more configuring interventions to run whose goal is to gather unknown information and configure one or more of the selected configurable interventions in order to make the configurable interventions specific to a user. (Examples of unknown variables could be the location of pain during flexion of the knee or a further example might be a comparison between a user's healthy knee and an injured knee).

Certain user goals might not need any auxiliary information, for example, if a user simply inputted the scenario code of ‘basic rowing training with simulated realism and inputted a few requirements such as boat type and water current speed, interventions can be selected to provide a simulation without having to ‘know’ any further data about a user. If, however, the scenario code was ‘rowing training with simulated realism with conditioning then this would necessitate the calculation of specific data about the users current situation so that specific variables are available for use by selected intervention programs.

Once the selected configurable interventions have been configured, the control unit compiles them into a master algorithm providing a bespoke program tailored to a specific user. In this regard it should be noted that given a sufficiently open ended inputted scenario code no single program for any user would ever be the same as another one even if they had inputted the same scenario code.

Compiling the master algorithm can also include assigning different priorities to the different individual component algorithms in the master algorithm. The priorities can affect which algorithms take precedence. This can be important in order to provide a desired effect taking into account both short and long term objectives, to make the algorithm more effective, and also to improve safety. For example, at maximum limb extension muscle limits are more important than bone limits, and the system can assign priorities to the different algorithms in light of this and in dependence on the scenario code and operation data.

The control unit is operable continuously to monitor relevant variables as they are measured by the assembly and to review whether they are in compliance with the scenario code. The variables which are monitored are determined by the scenario code, however in some embodiments all possible variables of operation data are monitored. The control unit is operable to determine whether the operation data provided by the monitored variables is outside a first predetermined tolerance with regard to the scenario code and, if so, is operable to reconfigure one or more of the selected configurable interventions in dependence on the scenario code and the relevant operation data and to recompile the master algorithm in order to bring the assembly back into line with the scenario code.

The control unit is also operable to determine whether the operation data provided by the monitored variables is outside a second predetermined tolerance with regard to the scenario code and, if so, to select one or more further configurable interventions from the library and/or replace one or more of the selected configurable interventions from the library in dependence on the scenario code and the relevant operation data. The control unit is also operable to select one or more further non-configurable interventions from the library and/or to replace one or more of the selected non-configurable interventions from the library if appropriate in dependence on the scenario code and the relevant operation data. The control unit is operable to compile the master algorithm again using the new selection of algorithms. The control unit is also operable to reassign priorities to the different algorithms in dependence on the scenario code and the relevant operation data.

In other words, the control unit is operable to continuously reassess whether the currently selected interventions and the current configuration of the selected configurable interventions is appropriate and, if not, it is operable to either reconfigure appropriate ones of the configurable interventions or to select one or more different interventions from the library, in addition to or as a replacement for one or more of the previously selected interventions. This selection and/or reconfiguration is dependent on the scenario code and monitored variables of operation data. It can also be dependent on past operation data, which can be past values of the monitored variables and/or past values of other variables of operation data.

The result of this is that the control unit is configured constantly to readjust how it responds to a user's behaviour based on the past behaviour of the user and in view of a predetermined objective.

This means that the assembly is not restricted to a consistent and passive variation of force in response to a user's behaviour. In contrast, it is able to apply an active dynamically changing program which takes into account multiple aspects of the user's past and present activity.

For example, if an objective were to keep a certain resistance force, a passive system would simply apply a constant force. However, if the user were to change the angle at which he receives the force, the force the user actually receives would change. Embodiments of the present invention are able to respond to the change in conditions and adapt the selected interventions accordingly in order to comply with the original predetermined objective of providing a constant force.

In some embodiments, the scenario code can be input by the user using the display 28 for example if the display 28 is a touch screen. Or the scenario code may be input using a different input unit associated with the display 28. Alternatively, or in addition, the control unit may obtain the scenario code from data storage, for example in response to receiving personally identifying information such as biometric information communicated from the force receiving element. This data storage may be a local or remote data storage such as memory 32. The control unit may use the user's personally identifying information to ‘log in’ to a remote data storage which also stores the user's information.

As an example, where the display 28 is part of a user's personal device such as a smartphone or tablet computer, the personal device may be operable to execute an app which is able to obtain a predefined scenario code or a custom-made scenario code and provide it to the control unit. For example, the app may be operable to design scenario code, or it may be operable to obtain scenario code from a remote source. This may enable a physician or fitness instructor to design scenario code for a patient or client, and store that scenario code in a location where the control unit or personal device will be able to obtain it. This can be for example at a remote data storage or on portable data storage for connection to the assembly.

The control unit can in some embodiments obtain or be provided scenario code in app form from a cloud based work-out store.

For example, rather than the user needing to program in different workouts, he or she can go to an online store and download an interval workout designed by a famous footballer. This can then be customised to his or her own needs.

It is possible to have a variety of apps. In another example, the scenario code is linked with a user's music and prepares a workout down to the level of individual strokes that relate to the current song or playlist.

### Use

With reference to FIG. 5, the assembly can be used in the following way.

The force receiving element is coupled to the force application unit and the communication unit 19 communicates the personally identifying information stored within the force receiving element to the control unit 26.

In response to receiving the personally identifying information, the control unit obtains corresponding scenario code from either local or remote data storage.

The control unit selects one or more configurable interventions from the library as well as one or more non-configurable interventions as appropriate in dependence on the scenario code. As described above, at this point the interventions are not specific to the user.

A user 34 then pulls on the handle 12 and exercises by extending and retracting the cable 16. As the handle 12 is operated, the detector 18 detects the force applied by the user to the handle 12 and other operation data associated with the force being applied to the handle 12, and communicates 36 this to the control unit 26. At the same time, the force application unit communicates 38 operation data obtained by the force meter 20 and rotary encoder 22 to the control unit 26. The control unit stores operation data in the memory for future reference as past operation data.

The control unit obtains configuration data including certain variables of operation data in dependence on the scenario code. The variables of operation data which are obtained for the configuration data can be influenced by the interventions which were selected.

The configuration data is then used by the control unit to configure the selected configurable algorithms and to compile the selected algorithms into the master algorithm.

The control unit operates a real time feedback loop, operating the force application unit 14 in accordance with the master algorithm to adjust the force applied to the handle in accordance with the data received from the handle 12 and the force application unit 14.

All possible parameters in which data may be generated are logged. This data is reviewed as described above for compliance with the scenario code. This data is used to make a decision as to whether the user is in keeping with the scenario code and whether or not the system is functioning correctly to allow the user to achieve their desired goals. If this is not the case, the control unit then once more carries out the intervention selection and/or compilation and configuration procedure. If the currently selected interventions need not be changed (new ones added or taken away) then the system will reconfigure the selected configurable interventions, for example by changing some of the parameters of the currently selected configurable interventions and recompile the master algorithm. If, at any given moment all collected data matched perfectly with the scenario code (in other words the bespoke profile is working and the user is managing to carry out the profile) then no changes would need to be made and the cycle may continue as normal.

The system described herein is able to adapt to a user and create a completely bespoke profile.

The system may act at varying levels of complexity to achieve its goals. If we imagine a system in a cable multigym embodiment, the simplest manifestation of the device might have simply a force meter at the handle. At the other end of the spectrum we might imagine a device with all possible kinematic sensors, a 3D scanner and a multitude of output options such as hardware reconfiguration and reconfiguration of the user environment e.g. floor shape. In both these scenarios, the continuous adaption process may work to generate a bespoke profile. In the first scenario, the limited sensing capabilities i.e. a force meter, limits both the data the device can acquire and the complexity of the device output. Here, differing interventions may still be selected however they will not be customisable and the total scope of possible interventions will be limited. Scenario code providing overarching programs may still be achieved—after all conventional free weights can be used to improve upper body strength however with the poor sensor array induced lack of customisability the delivered profiles will not be maximally efficient in allowing the user to achieve the overarching goal.

Embodiments of the invention use an adaptive process to generate bespoke programs for a user to allow them to achieve their overarching goal. Faster, more efficiently, achieving a better end outcome.

A schematic diagram showing how the assembly works in this embodiment is shown in FIG. 25.

Box A represents a user, who may have attributes 400, such as live capture, historic data or a digital prescription.

Box B represents an objective, or scenario code. Examples of objectives or scenario code include comparative scenarios, strength scenarios, or conditioning scenarios. An objective or scenario code is selected by the user.

At box C, one or more configurable interventions are selected from the library of interventions, as well as possibly one or more non-configurable interventions. Examples of interventions include a simulated gravity of 9.8 Nkg⁻¹, a free weight simulation, a muscle protection simulation, and a safety intervention.

Box D represents a compiler which configures one or more of the configurable interventions and forms an overall master algorithm or program for operation from the interventions that have been selected and configured. This overall program is used to influence an output 410, which influences an interaction of the assembly with the user.

As the system is influencing the output, one or more inputs 420 are being measured and fed back to the system. These inputs provide operation data which can be used at box B to review whether the operation data is within a predetermined tolerance of the scenario code. If not, the operation data can be used to influence the selection of additional or replacement interventions at box C, while still being in keeping with the scenario code. Alternatively, or in addition, if the operation data is not within a predetermined tolerance of the scenario code, the operation data can be used to influence the configuration of the interventions in the master algorithm at box D.

### Modifications

Not all embodiments need to have a library of pre-programmed interventions. However, in general the control unit is operable continuously to monitor relevant variables as they are measured by the assembly and to calculate therefrom a suitable algorithm which is in accordance with the scenario code. The algorithm provides a desired relationship between the force applied by the force application unit and any number of the variables and is calculated to be in accordance with the scenario encoded by the scenario code. For example, the algorithm can provide the force to be applied by the force application unit as a function of any of the variables of operation data. For example, if the user was pulling the force receiving element to raise a virtual weight at a significant speed and then the variables indicate that the user suddenly reduces the force he is applying, the scenario code may indicate that the virtual weight has momentum and is affected by gravity. An algorithm may therefore be calculated which significantly reduces the force applied to the force receiving element (while the virtual cable goes slack as the momentum of the virtual weight continues to raise it) and then subsequently increases the force as the virtual weight falls back.

Furthermore, the control unit is configured to continuously recalculate the algorithm as new operation data is measured. The control unit is configured to operate the force application unit to apply a force in accordance with the algorithm.

During use the control unit can calculate an algorithm from the data from the handle and from the force application unit in accordance with the scenario code. As discussed above, the algorithm is a desired relationship between the force applied by the force application unit and any number of variables of data.

In addition, the control unit operates a real time feedback loop, operating the force application unit 14 in accordance with the algorithm to adjust the force applied to the handle in accordance with the data received from the handle 12 and the force application unit 14. At the same time, the control unit recalculates the algorithm in view of new data being measured.

This process is shown by the flow chart of FIG. 4 in which in step 1 the system is initiated. At step 2, sensory information is gathered, that is to say that data relating to the force receiving element and data from the force meter and the rotary encoder of the force application unit are communicated to the control unit 26. At step 3, the control unit 26 analyses the data received from the force receiving element and the force application unit and calculates an algorithm that complies with the scenario code. In step 4, the control unit compares received data to the scenario code. If the data is in accordance with the scenario code, the system reverts to step 2. However, if the data is not in accordance with the scenario code, the system proceeds to steps 5 and 6 at which the algorithm is modified in order to try to bring the data received from the force receiving element and the force application unit back into line with the scenario code.

In some embodiments, the force receiving element can be used without the force application unit. For example, the force receiving element can be connected to a conventional device such as weights on a cable. In such embodiments, the communication unit 19 can communicate measured operation data to a remote device such as a smartphone for example for storage and analysis or to enable the remote device to develop scenario code for the user when he or she uses a force application unit. In other embodiments, the communication unit 19 is not provided. In such embodiments, the force receiving element can be provided with a memory and can be configured to store operation data gathered by the detector 18. In some such embodiments, the force receiving element may be connectable to a computer or other electronic device to upload the stored operation data for example for review or analysis of any of the multiple data types that the assembly has captured or to enable the remote device to develop scenario code for the user when he or she uses a force application unit.

In some embodiments, the cable 16 is operable to send notifications through the cable such as different pulsations for example to notify user that they have just finished one set of exercises.

In addition or alternatively, pulsations and standing waves may be set up to re-create some of the effects of ‘vibration’ based exercise devices e.g. power plate.

In some embodiments, the force receiving element is operable to measure operation data from first and second ends of the force receiving element. The ability to incorporate and analyse input data from first and second inputs e.g. two force meters on either end of the force receiving element can ensure it is pulled out straight and level. FIG. 21 shows a schematic diagram of such an assembly. In this case measurement from both sides of the force receiving element may be taken into account to check if muscles within both limbs are taken into account.

In some embodiments, the cable 16 itself may house light emitters such as small LED's (or EL wire). These may sequentially be turned on and off during a stroke to convey information to assist a user with his or her exercise. For example, the lights may ‘mark’ a retraction or extension location at some point on the cable. An example is shown in FIG. 22, in which the illuminated section demarcates the linear location and length the stroke should be (in FIG. 22 the cable has been pulled out too far). In contrast, FIG. 23 shows a mid-stroke position where as indicated different parts of the cable are now lit up to indicate to the user that they are in an intermediate position through the stroke. The areas to light up are calculated by the control unit based on pre-set information about the required stroke such as calibrated start points and end points. The control unit is operable to use information from the rotary encoder to determine how far the cable has been retracted or extended and thus determine which area of the cable to illuminate.

In some embodiments, there may be a 3D display operable to show an indicator such as a little arrow on the handle that shows whether the user is on course during the stroke.

In some embodiments, augmented VR goggles may be provided which are operable to provide a line based overlay which can show the user the line to make the force receiving element follow.

In some embodiments, the force receiving element is coupled to an end of the cable 16, but can be coupled in other ways. As the force receiving element 312 is able to wirelessly send out the information it measures it can be physically coupled indirectly to the force application unit. For example, FIG. 24 shows a force application unit coupled to a first wall and a cable 316 coupled from the force application unit to a second wall with a free moving pulley 300 coupled to the cable 316 and able to move therealong. A force receiving element 312 is attached to the pulley 300.

Instead of the force receiving element containing personally identifying information, the personally identifying information can be transferred to the control unit in other ways. For example, an NFC tag/mobile phone NFC for a user can contain all relevant biometric information and shortcut to pre designed custom workout/physio plan. It can also contain injury data and a work-out log for that user. The assembly can include an NFC reader which is operable to obtain the information from the tag/phone. This is advantageous for example if a person is in a hotel and wants to use the device there, they can swipe the tag thus causing the device to behave in exactly the same way as every other device they have used—it becomes personalised. For example, the same force application unit can be used for rehabilitation or exercise or fun game-related simulation depending upon the user.

The assembly can have framework of a modern smartphone where it has the ability for ‘apps’ to be installed on it thus allowing a completely open ended functionality set.

### Applications

### Exercise

One particular use of the assembly according to the embodiment of FIG. 2 is for exercise, such as is shown in FIG. 5 (a). In FIG. 5 (a), the force application unit 14 is shown as being attached to a wall 40 by a frame 42 in order to prevent the force application unit from moving while the user is pulling on the force receiving element 12.

As explained above, the assembly can be configured with a variety of different scenario codes. The scenario code can be to imitate a particular exercise machine, such as a weight lifting machine. Alternatively, the scenario code can be a considerably more complex exercise regime which has been personally developed for the individual user to maximise their exercising efficiency. In an example, a personal trainer programmes specific movement of the cable in combination with changing weights whilst programming in the acceleration that he wants the user to carry out whilst doing the stroke.

FIG. 5 (b) shows the force application unit applying a resistance force as the user is pulling on the force receiving element 12, whereas FIG. 5 (c) shows the force application unit 14 applying a positive retraction force on the force receiving element 12 against which the user has to apply a resistance.

FIG. 6 shows a slightly different arrangement of the embodiment of FIG. 2 in which the user is moving the force receiving element in a vertical direction.

As shown in FIG. 7 the display 28 can show a comparison of the force, acceleration, velocity, or other operation data detected at the force receiving element or force application unit in comparison to a target as defined by the scenario code.

In one embodiment, the force receiving element is a strap which can be fastened around a user's torso, such as their waist, allowing the user to run against a force applied by the force application unit.

### Medical

### Injury Protection

Another important use of embodiments of the invention is in the medical field as diagnostic or therapeutic devices. For example, if a patient has an injury, such as an injured muscle, there may be areas of pain or weakness in which it is difficult to exercise. FIG. 8 is a schematic diagram of use of the assembly by a patient with an injury in his or her muscle.

In a corresponding manner to that explained above, embodiments of the present invention can be configured so that a user can operate the force receiving element at a constant speed. However, it is inappropriate simply to configure the assembly to operate at a constant speed since such a simplistic configuration would allow the user to complete the exercise irrespective of how much effort they wanted to put in. If they decided to put less effort in, the device would simply reduce the applied force to compensate.

In contrast, embodiments of the present invention can be personally calibrated so that a user can operate at a reduced force over an area of weakness. For example, the user can operate at a constant speed, but without necessarily a constant force.

In order to configure the assembly, a scenario code is created. This is done with a calibration stage.

In the calibration stage, the assembly is configured to operate at a constant speed and the user operates the assembly with maximum effort in order to ‘assess’ the limb. The patient is asked to pull as hard as they can on the cable at all points whilst it unspools at a constant speed. Once the end point is reached or an end point is specified by the patient, the device rewinds the cable at a constant speed with the patient resisting the movement. The assembly in the calibration stage operates a simple ‘negative feedback’ behaviour however it does allow the device to find out the level of functionality of the limb through the stroke by analysing the force applied to the assembly at all points in the stroke. It can plot a chart of the total instantaneous power the user can generate at each point in their stroke.

As the patient reaches an area of pain or weakness caused by an injury, the force which they are able to apply may suddenly drop. Accordingly, the speed at which they are moving the force receiving element may increase or decrease as they are unable to overcome the force applied by the force application unit to the same degree.

The data communicated to the control unit 26 by the force receiving element 26 and/or the force application unit enables the control unit 26 to calculate therefrom the speed and thereby detect the change in speed.

In order to maintain the speed at its previous level, the control unit operates the force application unit to decrease the force applied to the force receiving element, while continuously monitoring and storing details of the force being applied by the user. This is done at a high refresh rate so that the force applied by the force application unit drops before the user has consciously realised what is happening. Therefore, the velocity of the force receiving element is maintained despite the force applied by the user being significantly reduced.

As the user exits the area of pain or weakness, the force applied by the user will increase again and the opposite effect occurs. The control unit detects the increase in speed and increases the force applied by the force application unit accordingly to maintain the speed at its previous level.

After a stroke, the control unit has therefore obtained a record of the maximum force that the user can apply at all points of the stroke.

The assembly can do this phase a number of times and average out the result to achieve the best possible ‘fit’ to the patient.

This process is shown in the flow chart of FIG. 9.

The ‘fit’ can be used to construct scenario code based on the force that the calibration stage has determined the user is able to produce at each point of a stroke. When the user is actually exercising, this scenario code can be used meaning that the assembly can demand a maximum force at all points of the stroke while being personally configured to be sensitive to that user's injury. It does not reduce the applied force depending upon the user's effort but applies a force based on what the scenario code indicates that the user can achieve. This can assist a user in recovering from a muscle injury and reduce the risk of muscle wasting.

In other words, a custom scenario is made from the calibration data which can be thought of in the following way: imagine a conventional stroke on a current generation conventional cable exercise device. Now picture the pin in the weight stack being moved mid stroke to vary the force at any particular given point (something that cannot be easily done at the moment). This is the basis of the scenario that is created for the user in embodiments of the invention. The user pulls the cable and feels as if they are lifting genuine weights attached to the cable (including momentum and gravity) but it will feel as if weights are being dynamically removed and added depending on where the initial calibration phase calculated the patient was experiencing pain within the stroke. If they were to stop moving the handle, the force will NOT drop to zero as would happen with the negative feedback device but the cable will halt statically keeping force applied as if the user has left dangling weights.

An additional benefit is no calibration of the start and finish points are required for the stroke as if the user stops mid stroke and reverses the direction of the stroke the assembly can simply follow the change and continue along its bespoke created scenario.

Although the above description relates to a calibration aimed at generating a scenario based on the maximum force a user can apply at all points of a stroke, a calibration stage can be used to develop a scenario code based on any kinematic parameter that the assembly can measure, and the scenario code can be used in any of the applications or arrangements of the assembly, not necessarily injury protection. A calibration stage can be used for example to identify points in a stroke at which performance falls below a desired standard and to develop a scenario code to help improve that standard. An example is if a high performance athlete wants to increase the acceleration of a particular explosive movement. The assembly can be operated in a calibration mode but this time measuring peak accelerations. In this case, the assembly in the calibration mode can simulate a simple 10 kg weight and ask the user to extend the cable as fast as possible. The accelerations of the handle are measured and displayed on a screen. If there is a specific area where the athlete would like to be able to move faster it can be indicated on the display and a custom workout scenario code can be developed where increased virtual weights are added to the area over which the athlete wants to have increased acceleration. The athlete can then operate the assembly (no longer in calibration mode) to use this scenario code, getting used to the area of difficulty and building up muscle memory. Hence in real life they will be able to accelerate faster in this range of motion.

### Diagnosis

In addition to assisting a patient with an area of pain or weakness, the control unit 26 can also gather data relating to the use of the assembly by a user to assist in a method of diagnosis. In this diagnostic mode, the assembly may be operating a simple negative-feedback loop such as during the calibration stage described above. However, this is not necessary in all embodiments.

A user can apply a force to the force receiving element for a period of time, for example while completing an exercise regime. During this period of time, as described above, the force receiving element measures the force applied by the user to the force receiving element, and possibly other operation data, and communicates this to the control unit 26. In addition, the force application unit conducts measurements as described above and communicates them to the control unit 26. The control unit 26 analyses the data received from the force receiving element and/or the force application unit over the period of time. It can then output the results of its analysis for example in graphical form such as shown in FIGS. 10 and 11 to enable a physician to diagnose a condition. In other embodiments, the control unit is operable to analyse the data and compare the analysis to predetermined injury signatures and to output to the user a diagnosis. It can for example be used to accurately compare limbs on both sides.

FIG. 11(b) shows a deviation from a normal zone curve of the force applied by the force application unit during a stroke. This deviation can be indicative of a specific type of musculoskeletal damage, and can represent an injury signature. As explained above, a graph such as that shown in FIG. 11(b) can be output via the display 28 for diagnosis by a physician, or the control unit can identify the injury signature and output the diagnosis to the user via the display 28.

### Therapy

With regard to a therapeutic application, physicians are often reluctant to prescribe specific exercise regimes to patients on the basis that there is a risk that if a patient is unable to stick to the precise regimen and inadvertently overexerts a particular muscle, this can, not only fail to improve the patient's condition, but in some circumstances can exacerbate the condition. Embodiments of the invention address these problems by enabling scenario code to be provided for a patient which restricts the maximum force with which the patient is able to exercise a specific muscle group, thereby minimising the risk of the patient further injuring themselves.

As described elsewhere, a user may be scanned by a 3d scanner while operating the assembly in order to determine position information. Whilst being scanned, the user may use the assembly without a calibration procedure. A clinician can impose a constraint such as a force limit through a particular muscle group. With this constraint in place, the user will now be able to pick up the force receiving element, such as a handle, and operate the assembly in any way they would like. The scanner will scan the user and create a stick figure representation of the user's position. Given pre-saved data of the universal human musculature and skeletal structure, this information may be overlayed with the stick figure representation of the user. The force receiving element will measure all the aforementioned force, kinetic and orientation data and this will be fed back to the control unit. The control unit will combine this information with the scanner information thus resulting in a positional map in which the control unit knows the position of the user, the rough anatomical arrangement of their tendons and muscles, and the kinetic paramaters of the user's current motion, thus it will now be a Newtonian physics calculation to work out an approximation for the instantaneous forces travelling through any anatomical structure. A scenario code may now be implemented such that, regardless of the movement a user makes with the force receiving element, the control unit will ensure that it does not exceed a pre-set value through a particular structure.

Owing to the lack of need for static weights or bulky apparatus in embodiments of the invention, assemblies can be provided which can easily be used in a hospital setting. For example, assemblies according to embodiments of the invention can be attached to a hospital bed to allow a user to perform exercises without leaving the bed. As described above, the attending physician can configure the assembly to prevent more than a predetermined force being exerted on particular muscles. This can enable a bed-ridden patient to exercise and thereby reduce the risk of muscle-wasting.

However, the therapeutic advantages of embodiments the invention are not restricted to bed-ridden patients. Embodiments of the invention can be configured taking into account the level of fitness of the patient in order to allow the patient to derive the maximum benefit from the exercise without exposing the patient to the risk of overexertion.

In addition, in some embodiments of the invention, the assembly can be precisely calibrated to a specific patient by providing the control unit with details of the patient's position, for example using a position sensor such as a 3d scanner as described elsewhere in this description. A 3d scanner and software sees the user as a stick figure and also ‘sees’ the force receiving element. From the vector direction of movement of force applied and detected user movement approximate forces can be calculated in real time. Based on this information the control unit can precisely calculate based upon the data received from the force receiving element and force application unit the precise force at any given moment passing through a muscle, tendon, or ligament of the patient and is thereby able to provide even more precise limits over the exercise which an injured patient can perform.

In addition, a less complex calibration can be performed by inputting to the assembly what the user will be doing (from an internal library of exercises) and where start and end points are and what the limb lengths are.

### Assembly Arrangements

As explained above, assemblies according to embodiments of the invention can be arranged in a variety of configurations and for a variety of different sorts of exercises. Some such embodiments are described below.

FIGS. 12 (a) and (b) show two alternative ways of arranging the assembly of FIG. 2 in order to exercise different muscle groups.

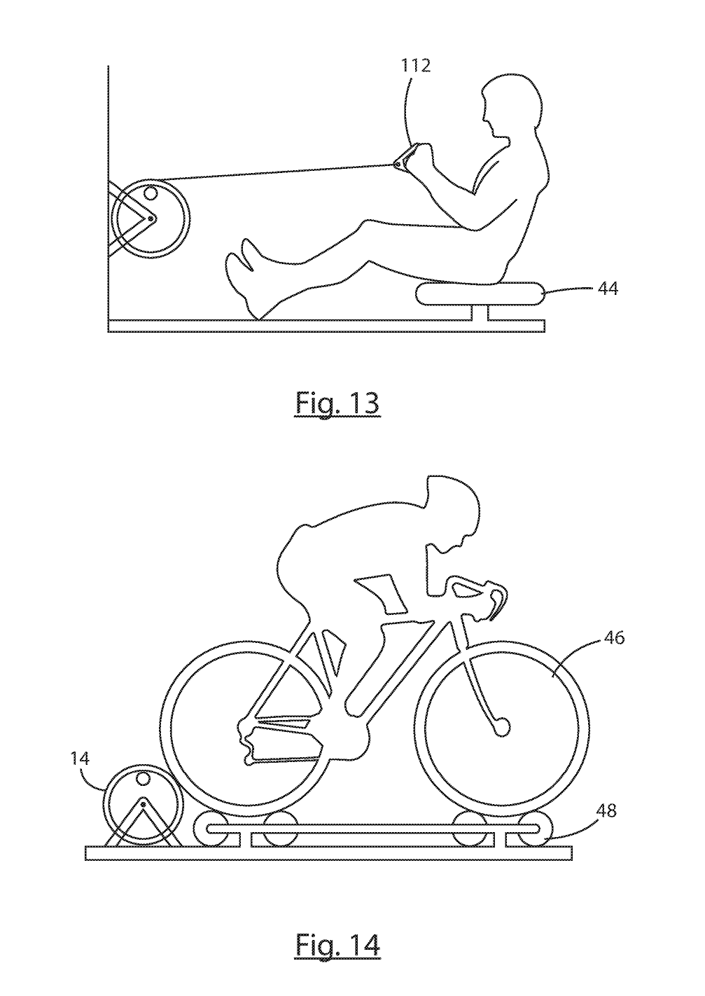

In FIG. 13 the force receiving element 112 includes a handle for a rowing machine, and the user is seated upon a movable seat 44. Accordingly, as the user operates the assembly, he is able to slide on the movable seat as though it were a conventional rowing machine.

In the embodiment of FIG. 13, the control unit may be configured to use scenario code which causes the control unit to change the force applied by the force application unit depending upon the position in the stroke of the force receiving element 112. For example, the control unit can operate the force receiving element to apply an increased force for the portion of the stroke which corresponds to the portion of a rowing stroke in which the oar would be in the water, and therefore subject to more resistance. In this way, the assembly of FIG. 13 is able to provide a more realistic rowing simulation than many known rowing machines. In addition, in the embodiment of FIG. 13, the movable seat can measure data such as the weight of the user and the position in the stroke and communicate this to the control unit for use in calculating or operating an algorithm. Data can also be measured by the handle such as orientation to make sure it is correct. If not correct, it can be fed back into calculating the algorithm and the effects will be felt.

In some embodiments, the user can wear video goggles to improve the virtual reality effect.

In a modification of the embodiment of FIG. 13, first and second force application units and force receiving elements can be provided, coupled to a common control unit. In this way, the assembly can simulate two different oars.

In the embodiment of FIG. 14 the user is seated upon a bicycle 46. The bicycle is supported on rollers 48 which enable the wheels of the bicycle to turn as the user pedals. In this embodiment, the force application unit 14 is located in contact with the back wheel of the bicycle. In this embodiment, the force receiving element is the pedals since they receive the force directly from the user. The force application unit is configured to apply a force directly to the back wheel of the bicycle, thereby to vary the resistance encountered by the user on the bicycle. In this embodiment, there is therefore no need for a cable since the coupling element is the bicycle itself.

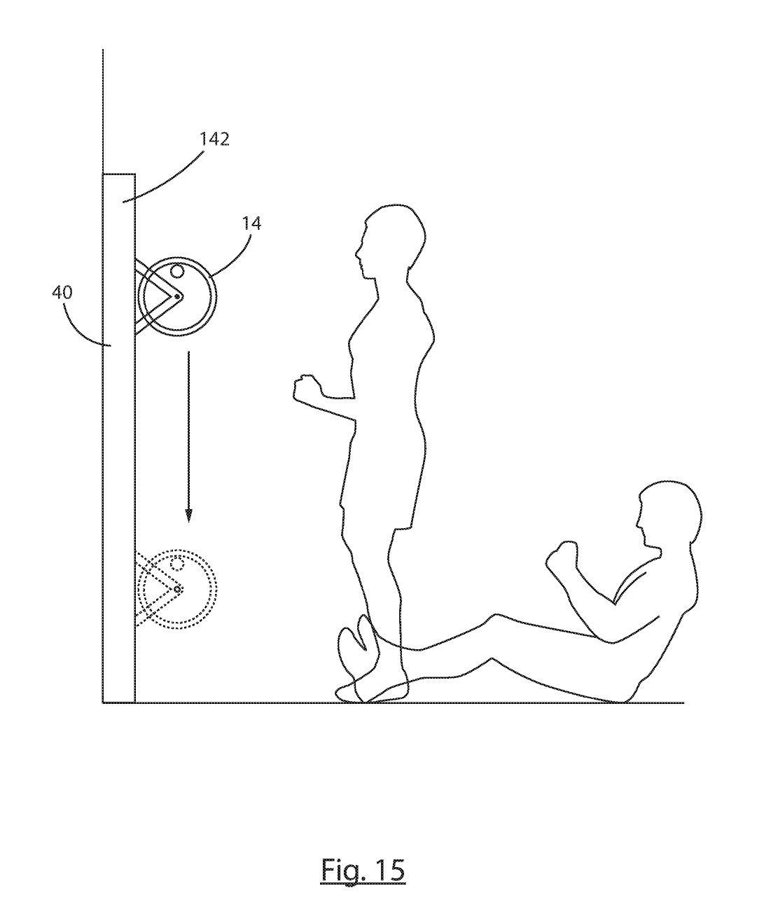

The embodiment of FIG. 15 resembles the embodiment of FIG. 5 (a) except that in the embodiment of FIG. 15 a much larger frame or rail 142 is placed against the wall 40 and the force application unit 14 is moveable on the frame 142, thereby allowing the force application unit 14 to be placed in different positions on the frame. This allows the force application unit to be used for different exercises. As shown in FIG. 15, a user is shown in two positions superimposed over each other, one in a standing position for performing an exercise resembling lifting weights, the other in a seating position for example for a rowing exercise.

In some embodiments of the invention the control unit is operable to move the force application unit 14 with respect to the frame 142, for example in order to comply with scenario code which the control unit is using. The scenario code may have been developed with information regarding the size of the user, and may therefore be able to cause the control unit to place the force application unit at an appropriate height for the user. Alternatively, or in addition, the scenario code may contain a range of different exercises for the user to perform, and as the user finishes one exercise the scenario code can cause the control unit to operate the frame to move the force application unit to a different position for the next exercise. Alternatively, or in addition, as part of an individual exercise the control unit may be operable to move the force application unit during a stroke in order to provide an optimal exercise movement arc or to vary the point of application and thereby the direction and vector angle of the applied force, for example to best exercise particular muscles.

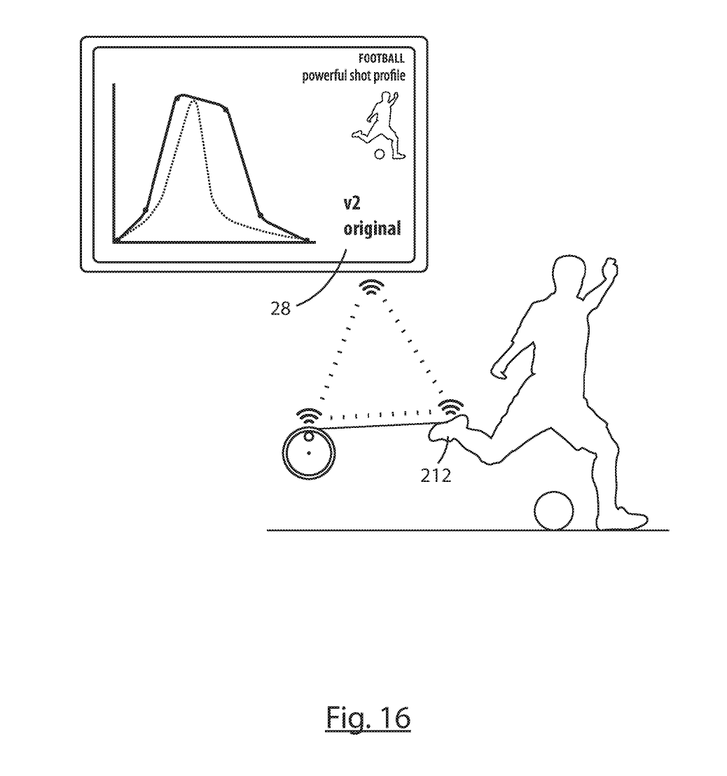

In the embodiment of FIG. 16 the force receiving element 212 is a football boot which is being worn by the user. The other components of the assembly remain substantially as described with respect to FIG. 2. In this embodiment, the assembly can simulate the kicking of a football. The scenario code employed by the control unit can effectively encode a virtual football. As described above, the control unit is configured to calculate an algorithm in dependence on the scenario code to govern the force applied by the force application unit. Accordingly, if the user is missing the virtual football, the algorithm can calculated to cause the force application unit to present a minimal resistance, irrespective of the force or length of the swing. In contrast, if the operation data indicates that the user is in line to kick the virtual football, the algorithm can be calculated to cause the control unit suddenly to increase the resistance force applied to the force receiving element 212 such as shown on the graph on the display 28 in FIG. 16 when the user's foot meets the virtual football. The fact that the algorithm is continuously being recalculated means that the algorithm will be responsive to slight changes in the user's behaviour, such as the angle of his swing, the speed his foot is moving, the location of the virtual impact relative to the virtual football and so on. All of this data can be used to mean that the algorithm at the moment the user strikes the virtual football causes the force application unit to apply an extremely realistic force pattern comparable to kicking a real football. However, the football can be an unrealistic football depending on training requirements, such as a football slightly ‘stuck’ to the ground or lighter than a usual football.

This increase in resistance can simulate the increased force that would be applied to the user's football boot at the moment of impact with a football. Similarly, the control unit can operate the force application unit to decrease the resistance again after the user has kicked the imaginary football.

Similar embodiments can be employed for other sports, for example, for a golf simulator, in which the force receiving element is a golf club shaped element.

As described above, the control unit can analyse the forces and movement of the force receiving element throughout the stroke, and is thereby able to provide an analysis and a review of the stroke, thereby enabling the athlete to review and improve his technique in a very closely controlled and monitored system.

Further improvements to the close control and monitoring particularly of exercises for particular sports, but also more generally, can be achieved in a multidimensional scenario. As shown in FIG. 17, an assembly according to an embodiment of the invention can be provided with multiple force application units 14 arranged around an exercise area. These can for example all be attached to a common frame 242 as shown in FIG. 18. Each of the force application units 14 are coupled to and able to communicate with the control unit 26. The control unit 26 is able to operate each of the force application units 14 independently but also simultaneously. In addition, each of the force application units is coupled physically to the force receiving element 12.

In this manner, depending upon the movement of the force receiving element and position of the force receiving element, the control unit 26 is able to apply a force to the force receiving element in a more than one dimension, thereby being able to simulate a more complex exercise regime.

In some embodiments, the control unit 26 is also operable to move each of the force application units 14 with respect to the frame 242 during the exercise thereby to vary the direction along which each of the force application units applies its force. In this way, the control unit is operable to vary continuously the magnitude and direction of the force applied to the force receiving element.

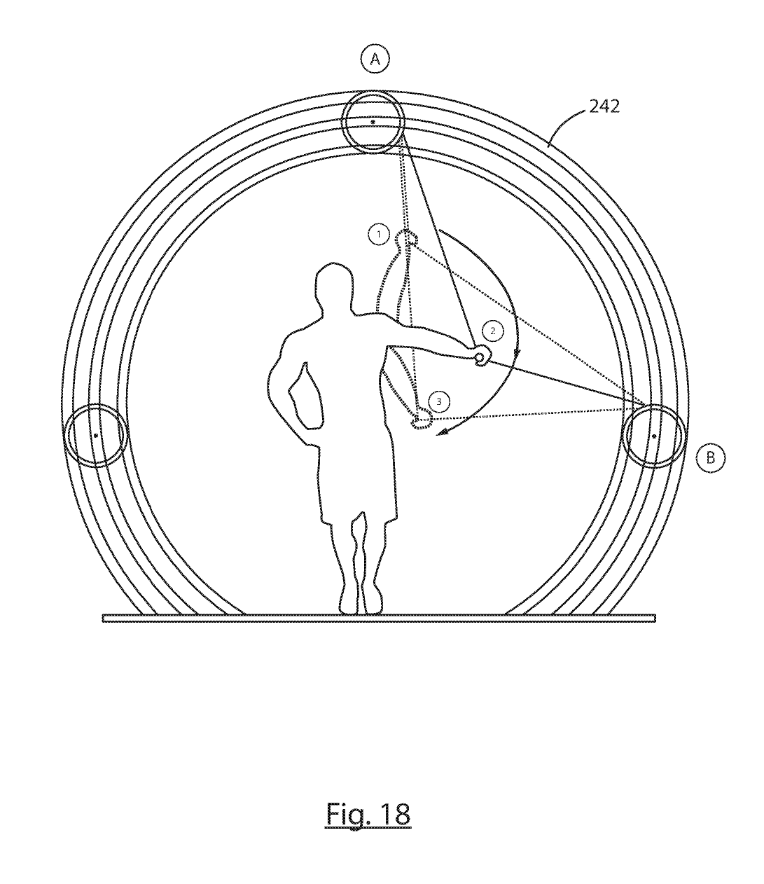

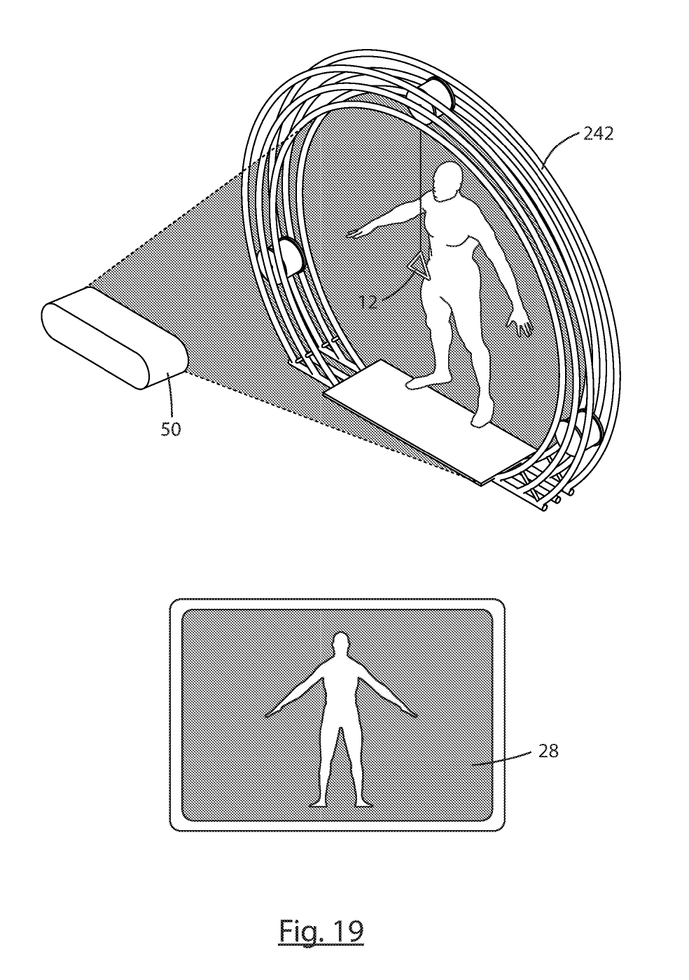

In the embodiment of FIG. 19, a scanner 50 is provided which is operable to scan the three dimensional position of the user within an exercise space within the frame 242. The scanner can for example be a Kinect™ sensor produced by Microsoft™. The scanner 50 is coupled to the control unit 26 and is operable to communicate to the control unit data concerning the position of the user within the exercise space. This data can specifically identify the position of the user's limbs and the position of the force receiving element 12 within the exercise space. In response to this data, the control unit is operable to adapt the position of the force application units within the frame 242, and the magnitude of the forces applied by the force application units on the force receiving element 12. The relationship between the position of the user and the position of each force application unit and the force applied by each force application unit can be guided by the algorithms discussed above. In this way, increased interaction between the control unit and the user is possible.

For example, the user can observe a virtual exercise or game being presented on the display 28 such as a virtual game of tennis. The control unit can analyse the data received from the sensor 50 and include a virtual user in the game corresponding to the position of the user within the exercise space. The user can watch the virtual game developing on the display 28 and observe his position within it. In response to this, the user can move, for example to try and hit a tennis ball. The control unit is able to monitor the position and movement of the user while also processing the virtual game which is being displayed. The control unit is therefore able to apply forces to the force receiving element corresponding to what is occurring within the virtual game.

For example, when the control unit detects that the virtual user is about to strike a virtual tennis ball, the control unit can impose a peak in the force applied to the force receiving element thereby to simulate the force of hitting the ball, thereby making the game more realistic. This is shown more clearly in the graph shown at FIG. 20.

The gaming embodiments can also be combined with training and rehabilitation such as described above, for example by developing the scenario code with assistance from a calibration stage as described above. In addition, parameters can be configured to be unrealistic if that would suit the user better.

Although the display 28 is described here as presenting the virtual scenario to the user, this display may be the same or may be a different display as compared to the display 28 via which the user operates a GUI to control the scenario code which is operated by the assembly.

In some embodiments, the energy generated by the user's operation of the assembly can be used to power the force receiving element, the force application unit and/or the entire assembly. If the energy generated by the user's operation of the assembly is greater than is needed for operation of the assembly, the additional energy can be provided to a mains power or electrical grid system.

All optional and preferred features and modifications of the described embodiments and dependent claims are useable in all aspects of the invention taught herein. Furthermore, the individual features of the dependent claims, as well as all optional and preferred features and modifications of the described embodiments are combinable and interchangeable with one another.

The disclosures in British patent application No. 1313214.7 and in the abstract accompanying this application are incorporated herein by reference.

1. A method of operating an assembly for applying a force to a user,
wherein the assembly includes a force application unit and a force receiving element,
wherein the force application unit is operable to apply a force to the force receiving element; the method including:
obtaining or selecting a scenario code, the scenario code governing a virtual environment or objective for a user's operation of the assembly;
selecting one or more configurable algorithms from a library in dependence on the scenario code, the library including a plurality of configurable algorithms, the one or more configurable algorithms being for influencing an interaction between the assembly and a user;
obtaining operation data in dependence on the scenario code, the operation data providing a measurement relating to a user's operation of the assembly;
configuring and compiling into a master algorithm the one or more configurable algorithms in dependence on the scenario code and the operation data.

2. A method according to claim 1, including operating the force application unit to apply a force to the force receiving element in accordance with the master algorithm.

3. A method according to claim 2, wherein operating the force application unit to apply a force to the force receiving element in accordance with the master algorithm includes operating the force application unit to apply a force to the force receiving element in accordance with an output of the master algorithm, the output of the master algorithm being dependent on the operation data.

4. A method according to claim 1, wherein configuring and compiling into a master algorithm the one or more configurable algorithms in dependence on the scenario code and the operation data includes assigning a priority to each of the one or more configurable algorithms within the master algorithm.

5. A method according to claim 1, wherein a measurement relating to a user's operation of the assembly includes a measurement of a position and/or movement of a user and/or relating to a force applied by a user.

6. A method according to claim 1, including selecting from the library, in dependence on the scenario code and/or the operation data, one or more calculation algorithms for performing calculations on the operation data, and compiling the one or more calculation algorithms into the master algorithm, wherein an output of the master algorithm is dependent on a calculation from the one or more calculation algorithms.

7. A method according to claim 1, wherein the one or more configurable algorithms are for influencing a force applied to the force receiving element.

8. A method according to claim 1, wherein the library includes a plurality of configuring algorithms for influencing the configuration of other algorithms, and the method includes selecting from the library, in dependence on the scenario code and/or the operation data, one or more configuring algorithms, and compiling the master algorithm whereby one or more of the one or more configurable algorithms is configured in dependence on the one or more configuring algorithms.

9. A method according to claim 8, wherein the one or more configuring algorithms are for performing a calculation on the operation data, and the method includes compiling the master algorithm whereby one or more of the one or more configurable algorithms is configured in dependence on the calculation.

10. A method according to claim 1, including compiling the master algorithm whereby a second algorithm is configured in dependence on a first algorithm, the operation data and the scenario code.

11. A method according to claim 1, including selecting the one or more configurable algorithms from the library in dependence upon the scenario code and the operation data.

12. A method according to claim 1, including reviewing the operation data for compliance with the scenario code and if the operation data is outside a predetermined tolerance:
changing which algorithms are included in the one or more configurable algorithms in dependence on the scenario code and the operation data; and
compiling into the master algorithm the one or more configurable algorithms in dependence on the scenario code and the operation data.

13. A method according to claim 12, wherein compiling into the master algorithm the one or more configurable algorithms in dependence on the scenario code and the operation data includes configuring and compiling into the master algorithm the one or more configurable algorithms in dependence on the scenario code and the operation data.

14. (canceled)

15. A method according to claim 1, including:
reviewing the operation data for compliance with the scenario code; and, if the operation data is outside a predetermined tolerance;
reconfiguring and/or recompiling into the master algorithm the one or more configurable algorithms in dependence on the scenario code and the operation data.

16. A method according to claim 15, wherein reconfiguring and recompiling into the master algorithm the one or more configurable algorithms in dependence on the scenario code and the operation data includes reassigning a priority to each of the one or more configurable algorithms within the master algorithm.

17-18. (canceled)

19. A method according to claim 1, wherein:
selecting one or more configurable algorithms from a library;
configuring and compiling into a master algorithm the one or more configurable algorithms;
changing which algorithms are included in the one or more configurable algorithms;
compiling into the master algorithm the one or more configurable algorithms; and/or
reconfiguring and/or recompiling into the master algorithm the one or more configurable algorithms;
is dependent on past operation data.

20. (canceled)

21. A method according to claim 1, wherein the operation data includes data indicating a position of a user and data indicating a position of the force receiving element.

22. A method according to claim 21, including determining a force through a predetermined body part of a user using a force measurement algorithm, the force measurement algorithm using the data indicating a position of a user and the data indicating a position of the force receiving element.

23. A method according to claim 22, including limiting a force through a predetermined body part of a user using the force measurement algorithm.

24. A method according to claim 1, wherein the operation data includes first, second and third classes of variables; wherein the first, second and third classes of variables relate, respectively to position, orientation, and kinematic variables, of at least one component of the assembly, or of the user.

25-47. (canceled)
